(19) United States
(12) Patent Application Publication
(10) Pub. No.: US 2017/0192644 A1
(43) Pub. Date: Jul. 6, 2017

(54) Accessing Additional Search Results Functionality Using Gestures

(71) Applicant: Quixey, Inc., Mountain View, CA (US)

(72) Inventors: Thomas FRANCIS, Dubuque, IA (US); Gilead MARK, Palo Alto, CA (US)

(21) Appl. No.: 15/229,072

(22) Filed: Aug. 4, 2016

Related U.S. Application Data
(60) Provisional application No. 62/273,534, filed on Dec. 31, 2015.

(51) Int. Cl. G06F 3/0488; G06F 3/0484; G06F 3/041; G06F 17/30; G06F 3/044

(52) U.S. Cl. CPC G06F 3/0488; G06F 17/30424; G06F 17/30554; G06F 17/30876; G06F 3/044; G06F 3/0414; G06F 3/04842

(57) ABSTRACT

Techniques include transmitting a search query to a search system and receiving search results from the system. Each result may include an access URL specifying a first state of a software application (app), the first state associated with an entity and a function performed for the entity, and a function URL specifying a second state of a software app, the second state associated with the same entity and a different function performed for the entity. The techniques further include, for each result, displaying a first user-selectable link configured to, upon being selected by a user input having a first type, set a software app into the first state, and, upon being selected by a user input having a second type, display a second user-selectable link configured to, upon being selected by a user input having the first type, set a software app into the second state.

### CROSS-REFERENCE TO RELATED APPLICATION

This application claims the benefit of U.S. Provisional Application No. 62/273,534 filed on Dec. 31, 2015, the entire contents of which are incorporated by reference.

### TECHNICAL FIELD

This disclosure generally relates to the field of search, and more particularly to techniques for generating search results that correspond to states of software applications.

### BACKGROUND

In recent years, the use of computers, smartphones, and other Internet-connected computing devices has grown significantly. Correspondingly, the number of software applications (apps) available for such computing devices has also grown. Today, many diverse software apps can be accessed on a number of different computing devices, including smartphones, personal computers, automobiles, and televisions. These software apps may include business driven apps, games, educational apps, news apps, shopping apps, messaging apps, media streaming apps, and social networking apps. Because of the large number of software apps available today and the wide range of functionality they provide, computing device users often require the ability to search for and access specific software app functionality.

### SUMMARY

In one example, a method comprises receiving, at a user device, a search query from a user, transmitting the search query to a search system, and in response to transmitting the query, receiving search results from the search system. In this example, each search result includes an access uniform resource locator (URL) that specifies a state of a software application (app), the state associated with an entity and a function performed with respect to the entity, and a function URL that specifies a different state of a software app, the different state associated with the same entity and a different function performed with respect to the same entity. The method further comprises, for each search result, displaying at the user device, a first user-selectable link configured to, upon being selected by a user input having a first type, cause the user device to set a software app into the state specified by the access URL included in the result, and upon being selected by a user input having a second type, cause the device to display a second (different) user-selectable link. In this example, the second user-selectable link is configured to, upon being selected by a user input having the first type, cause the user device to set a software app into the different state specified by the function URL included in the search result. The method further comprises receiving a first user input having the second type, the input selecting the first user-selectable link displayed for a first one of the search results and, in response to receiving the input, displaying the second user-selectable link associated with the first result. The method further comprises receiving a second user input having the second type, the input selecting the first user-selectable link displayed for a second one of the search results and, in response to receiving the input, displaying the second user-selectable link associated with the second result. In this example, the second user-selectable links displayed in response to receiving the first and second user inputs are different.

In another example, a method comprises receiving, at a user device, a search query from a user, transmitting the query to a search system, and in response to transmitting the query, receiving search results from the system. In this example, each search result includes an access URL that specifies a state of a software app, the state associated with an entity and a function performed with respect to the entity, and a function URL that specifies a different state of a software app, the different state associated with the same entity and a different function performed with respect to the same entity. The method also comprises, for each search result, displaying a first user-selectable link configured to, upon being selected by a user input having a first type, cause the device to set a software app into the state specified by the access URL included in the result and, upon being selected by a user input having a second type, cause the device to display second and third different user-selectable links. In this example, the second user-selectable link is configured to, upon being selected by a user input having the first type, cause the user device to set a software app into the different state specified by the function URL included in the search result. Also in this example, the third user-selectable link is configured to, upon being selected by a user input having the first type, cause the user device to set a software app into the different state specified by the function URL included in another search result. In this example, the first user-selectable links displayed for the two search results are displayed adjacent to one another.

In another example, a computing device comprises a network interface component configured to communicate with a network, an input/output (I/O) component configured to receive a search query and first and second user inputs from a user, a display, one or more memory components configured to store computer-readable instructions, and one or more processing units configured to execute the instructions. In this example, the instructions, when executed by the processing units, cause the processing units to receive the search query from the user using the I/O component, transmit the query to a search system via the network using the network interface component and, in response to transmitting the query, receive search results from the search system via the network using the network interface component. In this example, each search result includes an access URL that specifies a state of a software app, the state associated with an entity and a function performed with respect to the entity, and a function URL that specifies a different state of a software app, the different state associated with the same entity and a different function performed with respect to the same entity. The instructions further cause the processing units to, for each search result, display at the display a first user-selectable link configured to, upon being selected by a user input having a first type, cause the computing device to set a software app into the state specified by the access URL included in the result and, upon being selected by a user input having a second type, cause the device to display at the display a second (different) user-selectable link. In this example, the second user-selectable link is configured to, upon being selected by a user input having the first type, cause the computing device to set a software app into the different state specified by the function URL included in the search result. The instructions further cause the processing units to receive the first user input from the user using the I/O component, the input having the second type and selecting the first user-selectable link displayed for a first one of the search results and, in response to receiving the input, display at the display the second user-selectable link associated with the result. The instructions also cause the processing units to receive the second user input from the user using the I/O component, the input having the second type and selecting the first user-selectable link displayed for a second, different one of the search results and, in response to receiving the input, display at the display the second user-selectable link associated with the result. In this example, the second user-selectable links displayed in response to receiving the first and second user inputs are different.

In another example, a method comprises receiving, at a user device, a search query from a user, transmitting the search query to a search system, and in response to transmitting the query, receiving search results from the search system. In this example, each search result includes an access URL that specifies a state of a software app, the state associated with an entity and a function performed with respect to the entity, and a function URL that specifies a different state of a software app, the different state associated with the same entity and a different function performed with respect to the same entity. The method also comprises, for each search result, displaying a first user-selectable link configured to, upon being selected by a user input having a first type, cause the user device to set a software app into the state specified by the access URL included in the result and, upon being selected by a user input having a second type, cause the device to display a second user-selectable link. In this example, the second user-selectable link is configured to, upon being selected by a user input having the first type, cause the user device to set a software app into the different state specified by the function URL included in the search result.

### BRIEF DESCRIPTION OF DRAWINGS

The details of one or more examples are set forth in the accompanying drawings and the description below. Other features, objects, and advantages will be apparent from the description and drawings, and from the claims.

FIG. 1 illustrates an example environment that includes a search system, a function result generation system, data sources, and user devices that communicate via a network.

FIG. 2 illustrates an example user device in communication with an example search system and an example function result generation system.

FIG. 3A is a functional block diagram of an example search system.

FIG. 3B is a functional block diagram of an example search module.

FIGS. 4A-4B illustrate example state records.

FIG. 5 is a functional block diagram of an example function result generation system included in a search system.

FIGS. 6A-6B illustrate example entity records.

FIGS. 7A-9C depict example graphical user interfaces (GUIs) that may be generated on a user device according to the present disclosure.

FIG. 10 is a flow diagram that illustrates an example method for generating search results and function results based on a search query using a search system.

FIGS. 11-12 are flow diagrams that illustrate example methods for generating search results and function results based on a search query using a user device.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of this disclosure.

The present disclosure generally relates to the field of search, and, more particularly, to techniques for generating and displaying search results that specify states of software applications (apps). Using the techniques described herein may, in some examples, improve user experience. According to the disclosed techniques, a user of a user device (e.g., a mobile device) may input a search query (e.g., a text string) into a search field of a search app executing on the device. The user may then cause the user device (e.g., the search app) to transmit the search query to a search system. The search system may receive the search query from the user device, generate one or more search results that each specify a state of a software app, and transmit the results to the device. The user device may receive the search results from the search system and display each result to the user as a user-selectable link with text and images.

The user may select (e.g., touch, push, click on, or perform a gesture with respect to) one of the user-selectable links associated with one of the search results, which may be referred to as a “first user-selectable link,” using a user input having a first type (e.g., a momentary tap, push, or click, a shallow push, or a first gesture). Upon the user selecting the first user-selectable link, the user device may launch a software app and set the app into a state specified by the selected first link. In this example, the state may be associated with an entity (e.g., a particular business) and a function (e.g., “read user reviews”) performed with respect to the entity in the state. The user may interact with the state on the user device (e.g., preview the state and/or perform the function). Alternatively, instead of selecting the first user-selectable link using a first type of user input, the user may select the first user-selectable link using a second type of user input (e.g., a prolonged tap, push, or click, a deep push, or a second, different gesture). Upon the user selecting the first user-selectable link in this manner, the user device may display one or more second user-selectable links that are different than the first user-selectable link (e.g., as part of a list or a menu). For example, the user device may display a single second user-selectable link in response to the second type of user input. As another example, the user device may display a plurality of second user-selectable links as a list or menu, which may be referred to as a “function list” or a “function menu.” As described herein, the number of second user-selectable links may vary for each of the first user-selectable links (e.g., for each of the search results).

Assuming a single second user selectable link is displayed, the user may select the second user-selectable link using a user input having the first type, upon which the user device may launch a software app and set the app into a different state specified by the selected second link. In this example, the different state may be associated with the same entity (e.g., the same business) and a different function (e.g., “make a reservation”) performed with respect to the entity in the second state. The user may interact with the different state on the user device (e.g., preview the state and/or perform the different function). Accordingly, the techniques of this disclosure may enable the user to access additional functionality associated with the search results using user inputs of varying types (e.g., momentary or prolonged taps, pushes, or clicks, shallow or deep pushes, or different gestures), thereby improving the user's experience.

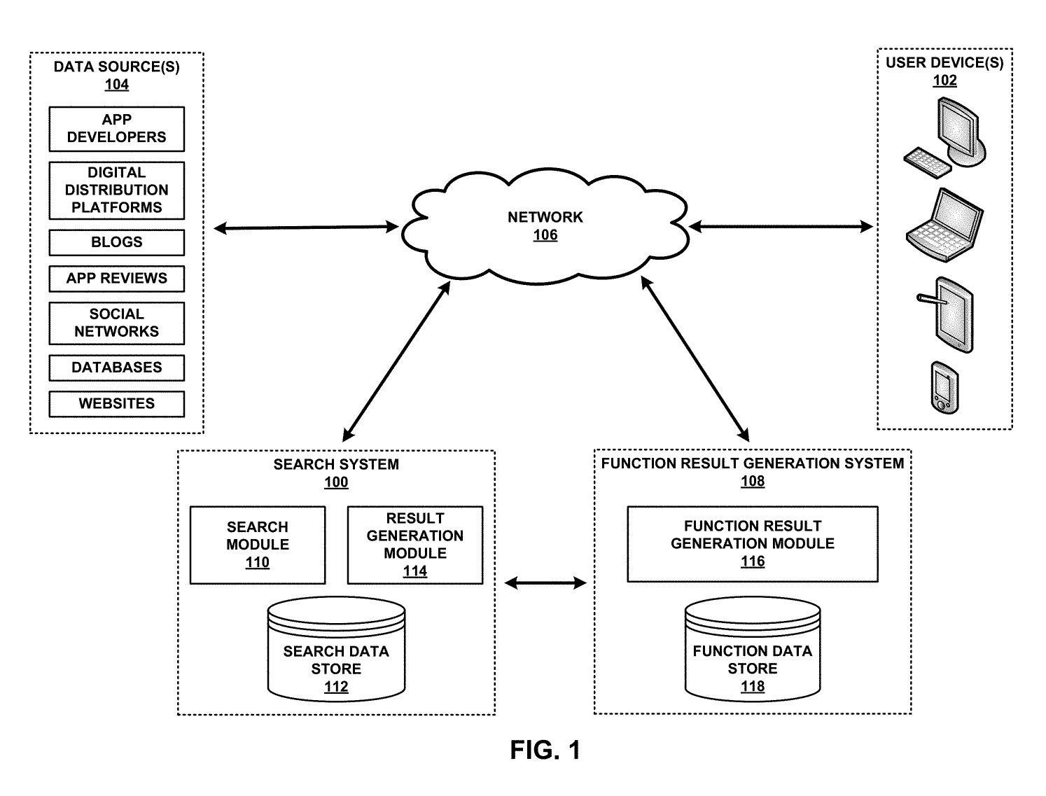

FIG. 1 illustrates an example environment that includes a search system 100, a function result generation system 108, one or more data sources 104, and one or more user devices 102 that communicate via a network 106. The network 106 through which the above-described systems and devices communicate may include any type of network, such as a local area network (LAN), a wide area network (WAN), and/or the Internet. As shown in FIG. 1, the search system 100 includes a search module 110, a search data store 112, and a result generation module 114. As also shown, the function result generation system 108 includes a function result generation module 116 and a function data store 118. In some examples, the function result generation system 108 may be a part of the search system 100, a part of another system or device, or a stand-alone system or device.

In the example of FIG. 1, the search system 100 receives a search query from one of the user device(s) 102 and generates search results in response to receiving the query. Specifically, the search system 100 generates the search results based on the search query and information included in one or more state records stored in the search data store 112. For example, each state record may include data related to a state of a software app. The information included in the state records may include one or more access URLs that enable the user device(s) 102 to access the states specified by the records. The search system 100 transmits the access URLs included in the state records to the user device 102 as part of the search results, as described herein. The state records may also include state information (SI) (e.g., text) and other data (e.g., state identifiers (IDs)), which the search system 100 may use to identify the records in the search data store 112. In this example, the search system 100 (e.g., using the function result generation system 108) further determines function URLs for the access URLs included in the state records. The function URLs enable the user device(s) 102 to access additional states of software apps (e.g., states in addition to those of the initial search results). The search system 100 transmits the search results, including the access URLs and the function URLs, to the user device 102, which displays the results to a user of the device 102 as one or more user-selectable links that include the URLs.

To generate the search results, the search module 110 may identify one or more state records included in the search data store 112 based on the search query. Initially, the search module 110 may analyze the search query. The search module 110 may then identify the state records using the search query (e.g., the analyzed search query). For example, the search module 110 may identify the state records based on matches (e.g., text matches) between terms of the search query and terms of information (e.g., SI and/or state IDs) included in the records. The search module 110 may further process the identified state records (e.g., generate result scores for the records). For example, the search module 110 may determine how well the identified state records match the search query. The search module 110 may then select one or more of the identified state records that best match the search query and transmit indications (e.g., state IDs) of the selected records to the result generation module 114. The result generation module 114 may identify the state records selected by the search module 110 in the search data store 112 using the received indications (e.g., state IDs). The result generation module 114 may select one or more access URLs from the identified state records. The result generation module 114 (e.g., using the function result generation system 108) may further determine one or more function URLs for the access URLs included in the identified state records, as described herein. The result generation module 114 may then transmit the selected access URLs and the determined function URLs to the user device 102 as the search results.

In some examples, the result generation module 114 may transmit additional data with the access URLs and the function URLs to the user device 102. For example, as described herein, the search module 110 may generate result scores for the state records from which the access URLs are selected (e.g., using values of metrics associated with the persons, places, or things described in the records and/or various features of the search query). As such, each access URL may be associated with a result score that indicates a rank of the URL relative to the other URLs. In some examples, the result generation module 114 may transmit the result scores associated with the access URLs to the user device 102 with the URLs. In other examples, the function result generation module 116 may generate result scores for the function URLs using any of a variety of techniques (e.g., based on whether the corresponding software app is installed on a user device 102). As a result, each function URL may be associated with a result score that indicates a rank of the URL relative to the other URLs. In these examples, the result generation module 114 may transmit the result scores associated with the function URLs to the user device 102 with the URLs. In still other examples, the result generation module 114 may transmit display data (e.g., text and/or image data) associated with the access URLs (e.g., with the corresponding state records) and/or the function URLs to the user device 102.

Upon receiving the search results from the search system 100, the user device 102 may display the results to the user as one or more user-selectable links. As described herein, each search result may include an access URL that specifies a state of a software app, the state associated with an entity and a function performed with respect to the entity, and a function URL that specifies a different state of a software app, the different state associated with the same entity and a different function performed with respect to the same entity. In some examples, the user device 102 may, for each search result, display a first user-selectable link configured to, upon being selected by a user input having a first type, cause the device 102 to set a software app into the state specified by the access URL included in the result. If the search result is selected by a user input having a second type (e.g., different than the first type), the device 102 may display a second user-selectable link that is different than the first user-selectable link. In these examples, the second user-selectable link may be configured to, upon being selected by a user input having the first type, cause the user device 102 to set a software app into the different state specified by the function URL included in the search result. In some examples, the user device 102 may set the software app into the different state specified by the function URL while continuing to display the second user-selectable link (e.g., set the app into the state in the background). In other words, in some examples, the user device 102 may set the software app into the different state specified by the function URL without displaying the state to the user (e.g., without taking the user to the state).

The user device 102 may further receive a first user input from the user having the second type, the input selecting the first user-selectable link displayed for a first search result. In response to receiving the first user input, the user device 102 may display the second user-selectable link associated with the first search result. The user device 102 may also receive a second, different user input from the user having the second type, the input selecting the first user-selectable link displayed for a second, different search result. In response to receiving the second user input, the user device 102 may display the second user-selectable link associated with the second search result. In these examples, the second user-selectable links displayed by the user device 102 in response to receiving the first and second user inputs may be different. In other words, the second user-selectable link associated with each of the first and second search results may be customized, or tailored to, the particular result. For example, each second user-selectable link may be configured to, upon being selected by the user input having the first type, cause the user device 102 to perform a function that is unique to the corresponding result.

In some examples, one or more of the first and second user inputs may each include a finger contact (e.g., a so-called “tap”) input received at a capacitive touchscreen of the user device 102. In other examples, one or more of the first and second user inputs may each include a pressure input (e.g., a so-called “push”) received at a pressure-sensitive display of the user device 102. In still other examples, one or more of the first and second user inputs may each include a cursor selection input (e.g., a so-called “click”) received via one or more of a computer mouse and a trackpad of the user device 102.

In some examples, one of the first and second types may include a momentary input having a relatively short time duration (e.g., a short tap, push, or click), and another one of the first and second types may include a prolonged input having a relatively longer time duration than that of the momentary input (e.g., a long tap, push, or click). In other examples, one of the first and second types may include a shallow input having a relatively small depression depth with respect to a pressure-sensitive display of the user device 102 (e.g., a so-called “shallow” push), and another one of the first and second types may include a deep input having a relatively large depression depth with respect to the display than that of the shallow input (e.g., a so-called “deep” push). In still other examples, one of the first and second types may include a first gesture with respect to a display of the user device 102 (e.g., a gesture having a particular geometry), and another one of the first and second types may include a second, different gesture with respect to the display (e.g., a gesture having a different geometry).

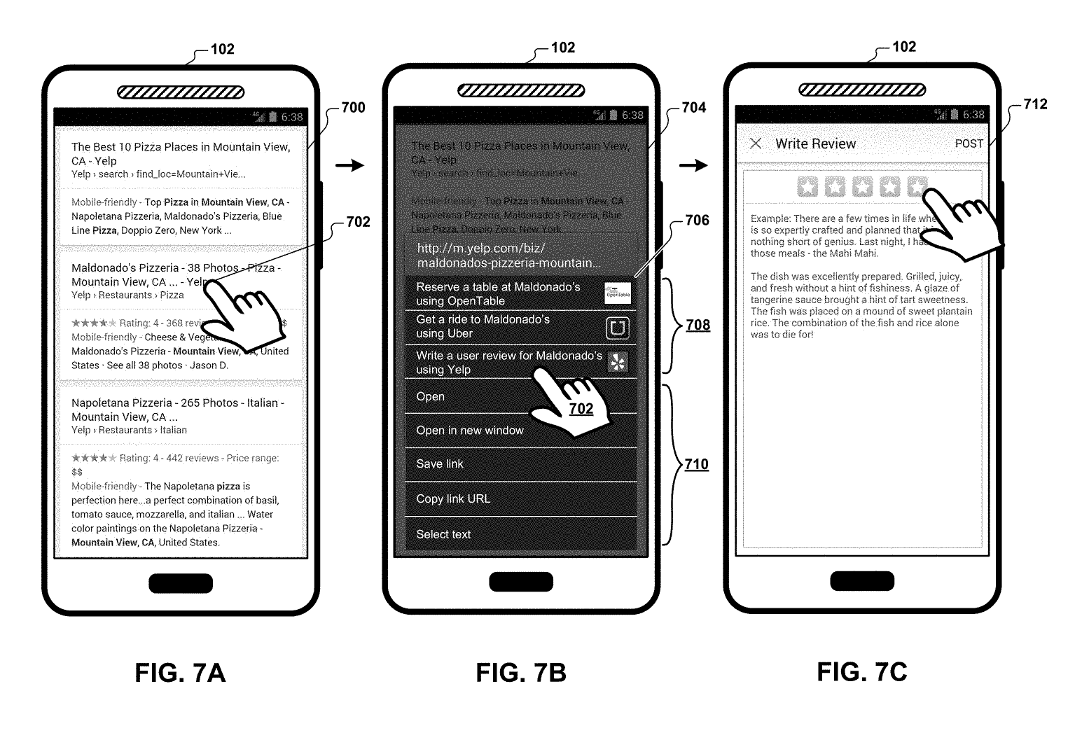

In some examples, the first user-selectable link displayed by the user device 102 for each search result may be further configured to, upon being selected by a user input having the second type, cause the device 102 to display a third, different user-selectable link adjacent to the second user-selectable link (e.g., as a list of user-selectable links). In these examples, the third user-selectable link may be configured to, upon being selected by a user input having the first type, cause the user device 102 to set a software app into a third, different state. Also in these examples, the user device 102 may be further configured to, in response to receiving the first and second user inputs from the user, display the third user-selectable links associated with the first and second search results. In these examples, the third user-selectable links may be the same. In other words, the third user-selectable link associated with each of the first and second search results may be configured to, upon being selected by the user input having the first type, cause the user device 102 to perform a standard function irrespective of the corresponding result (e.g., see a default menu 710 described with respect to FIGS. 7A-7B).

In some examples, for at least one search result, the first user-selectable link may be further configured to, upon being selected by the user input having the second type, cause the user device 102 to order the second user-selectable link in a list of user-selectable links based on whether the software app associated with the function URL included in the result is installed on the device 102. For example, the user device 102 may order the second user-selectable link in the list using a result score associated with the function URL.

In some examples, for at least one search result, the access URL and the function URL may specify states of the same software app. In other examples, the access URL and the function URL may specify states of different software apps.

In other examples, the user device 102 may display the search results to the user as the user-selectable links in a different manner. In these examples, the user device 102 may, for each search result, display a first user-selectable link configured to, upon being selected by a user input having the first type, cause the device 102 to set a software app into the state specified by the access URL included in the result, and, upon being selected by a user input having the second type, cause the device 102 to display second and third, different user-selectable links. In these examples, the second user-selectable link may be configured to, upon being selected by a user input having the first type, cause the user device 102 to set a software app into the different state specified by the function URL included in the search result. Also in these examples, the third user-selectable link may be configured to, upon being selected by a user input having the first type, cause the user device 102 to set a software app into the different state specified by the function URL included in another search result for which the first user-selectable link may be displayed adjacent to. In other words, the user device 102 may display the first user-selectable links for these two search results adjacent to one another (e.g., side-by-side in a list of first user-selectable links).

In some examples, the user input may include any of a finger contact input received at a capacitive touchscreen of the user device 102, a pressure input received at a pressure-sensitive display of the device 102, and a cursor selection input received via one or more of a computer mouse and a trackpad of the device 102, in a similar manner as previously described. The first and second types have also been previously described. In other examples, for at least one search result, the access URL and the function URL may specify states of the same software app, or different software apps, also in a similar manner as previously described.

In additional examples, for at least one search result, the first user-selectable link may be further configured to, upon being selected by the user input having the second type, cause the user device 102 to order at least one of the second and third user-selectable links in a list of user-selectable links based on whether the software app associated with the link is installed on the device 102, in a similar manner as previously described. For example, the user device 102 may order each of the second and third user-selectable links in the list using a result score associated with the function URL used to display the corresponding link.

In this disclosure, a software app may refer to computer software that causes a computing device to perform a task. In some examples, a software app may be referred to as an “app,” or a “program.” Example apps include word processing apps, spreadsheet apps, messaging apps, media streaming apps, social networking apps, and games. Apps can be executed on a variety of different computing devices. For example, apps can be executed on mobile computing devices, such as smartphones, tablets, and wearable computing devices (e.g., smart watches, fitness bands, and headsets, such as smart glasses). Apps can also be executed on other types of computing devices having other form factors, such as laptop computers, desktop computers, and other consumer electronic devices (e.g., smart home appliances, home networking devices, and home automation devices). In some examples, apps may be installed on a computing device prior to a user purchasing the device. In other examples, the user may download and install apps on the computing device after purchasing the device. A native app, as used herein, may refer to an app that is installed and executed on a user device. A web-based app, in turn, may refer to an app that is accessible from a user device via a web browser app.

In some examples, the functionality of an app may be accessed on the computing device on which the app is installed. Additionally, or alternatively, the functionality of an app may be accessed via a remote computing device. In further examples, all of an app's functionality may be included on the computing device on which the app is installed. Such apps may function without communication with other computing devices (e.g., via the Internet). In additional examples, an app installed on a computing device may access information from other remote computing devices during operation. For example, a weather app installed on a computing device may access the latest weather information via the Internet and display the accessed information to the user. In still other examples, an app (e.g., a web-based app) may be partially executed by a user's computing device and partially executed by a remote computing device. For example, a web-based app may be executed, at least in part, by a web server and accessed by a web browser app of a user's computing device. Example web-based apps include web-based email sites, online auction sites, online retail sites, and other websites.

An access URL and a function URL, as used herein, may each include any of a native app access mechanism (AM) (hereinafter, “app AM,” or “AAM”) and a web AM (hereinafter, “WAM”). As such, a user device 102 of the present disclosure may use an access URL or a function URL to access the functionality provided by a native or a web-based app. For example, a user of the user device 102 may select a user-selectable link that includes the access URL or function URL to access the functionality of the native or web-based app.

An AAM may be a string that references a native app and indicates one or more operations for a user device 102 (e.g., the app) to perform. If a user of the user device 102 selects a user-selectable link that includes the AAM, the device 102 may launch the native app and perform the operations. In other words, the user selecting the user-selectable link may cause the user device 102 to launch the native app and set the app into a state (e.g., in which the app displays a GUI, or screen). As a result, the native app may be configured to display one or more products, services, or vendors, to the user, e.g., via a display device of the user device 102. In this manner, the AAM may specify the state of the native app. The state, in turn, may refer to the outcome of the native app performing the operations in response to the user selecting the user-selectable link that includes the AAM.

A WAM may include a resource ID referencing a web resource (e.g., a page of a web-based app or website). For example, the WAM may include a URL (e.g., a web address) used with the hypertext transfer protocol (HTTP). If a user of a user device 102 selects a user-selectable link including the WAM, the device 102 may launch a web browser app included on the device 102 and retrieve the web resource referenced by the resource ID. Stated another way, if the user selects the user-selectable link, the user device 102 may launch the web browser app and access a state (e.g., a page) of a web-based app, or website, specified by the WAM. In some examples, a WAM included in a state record with an AAM may specify a state of a web-based app that is an equivalent of (e.g., analogous to) a state of a native app specified by the AAM.

In some examples an AAM may be associated with an app download mechanism (ADM). An ADM may specify a location (e.g., a digital distribution platform, such as Google Play® by Google Inc.) where a native app (e.g., a native app referenced by an AAM) may be downloaded. In some examples, a state record may include an ADM with an AAM (and a WAM). In these examples, the ADM may specify a location from which a native app referenced by the AAM may be downloaded.

The search query may include text, numbers, and/or symbols (e.g., punctuation) entered into the user device 102 by the user. For example, the user may have entered the search query into a search field, or “box,” of a search app executing on the user device 102. The user may have entered the search query using a touchscreen keypad, a mechanical keypad, and/or via speech recognition techniques and later caused the app to transmit the query to the search system 100. In some examples, the user may have entered the search query into the search app using various autosuggest (e.g., so-called “autocomplete”) techniques. In other examples, the search query may be generated or selected based on an interaction between the user and the user device 102, such as in response to the user selecting a link that corresponds to a predefined search query within an app executing on the device 102. In some examples, the search app may be a native app dedicated to search, or a more general app, such as a web browser app.

In some examples, the user device 102 may transmit additional data to the search system 100 along with the search query. The search query and the additional data may be referred to herein as a “query wrapper.” The additional data may include geo-location data associated with the user device 102, platform data for the device 102 (e.g., a type and/or a version, an operating system (OS), and/or a web browser app associated with the device 102), an identity of the user (e.g., a username), partner specific data, and/or other data (e.g., indications of one or more native apps that are installed on the device 102). The user device 102 may transmit the query wrapper to the search system 100. The search system 100 may receive the query wrapper and use the search query and the additional data included in the wrapper to generate the search results and provide the results to the user device 102.

In some examples, the search system 100 may transmit the search results, including the access URLs and function URLs, to the user device 102 with additional data. For example, the search system 100 may transmit display data (e.g., text and/or images) that the user device 102 may use to generate the user-selectable links for the access URLs and function URLs included in the search results. Each user-selectable link may include a portion of the display data that the user of the user device 102 may select (e.g., touch, push, or click on). Each user-selectable link may also be associated with one of the access and function URLs included in the search results, such that, when the user selects the link, the user device 102 sets a software app into a state specified by the corresponding URL. The display data included in each user-selectable link may indicate (e.g., textually and/or graphically) the state of the native or web-based app associated with the link and/or the app itself. Example user-selectable links are illustrated in FIGS. 7A-9C.

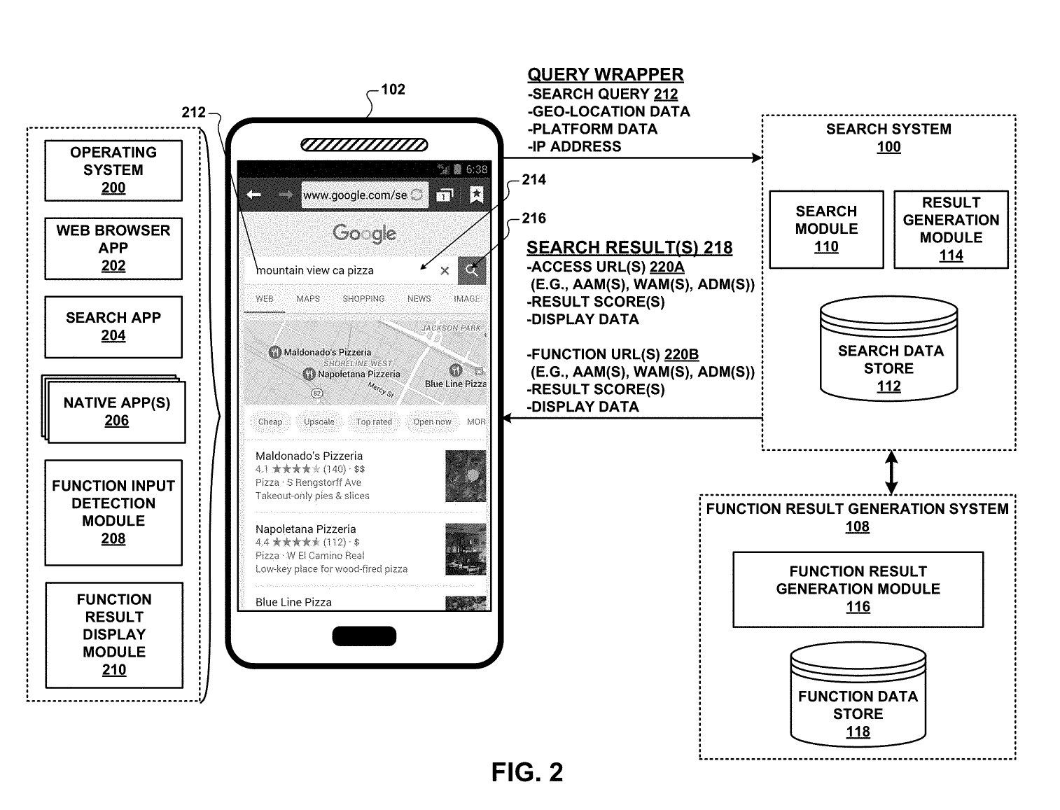

The user device(s) 102 may be any computing devices capable of providing search queries to the search system 100 and receiving search results from the system 100. The user device(s) 102 may include any of smartphones, tablet, laptop, and desktop computing devices. The user device(s) 102 may also include any computing devices having other form factors, such as those included in vehicles, gaming devices, televisions, or other appliances (e.g., networked home automation devices and home appliances). The user device(s) 102 may use a variety of different operating systems or platforms (e.g., an OS 200, as shown in FIG. 2). In the event the user device 102 is a mobile device, the device 102 may operate using an OS such as ANDROID® by Google Inc., IOS® by Apple Inc., or WINDOWS PHONE® by Microsoft Corporation. In the event the user device 102 is a laptop or desktop computing device, the device 102 may operate using an OS such as MICROSOFT WINDOWS® by Microsoft Corporation, MAC OS® by Apple Inc., or LINUX® (LINUX is the registered trademark of Linus Torvalds in the U.S. and other countries). Additionally, the user device(s) 102 may interact with the search system 100 using operating systems other than those described herein, whether presently available or developed in the future.

The user device(s) 102 may communicate with the search system 100 via the network 106. In general, the user device(s) 102 may communicate with the search system 100 using any app that can transmit search queries to the system 100 and receive search results from the system 100. In some examples, the user device(s) 102 may include an app that is dedicated to interfacing with the search system 100, such as an app dedicated to search (e.g., a search app 204, as also shown in FIG. 2). In other examples, the user device(s) 102 may communicate with the search system 100 using a more general app, such as a web browser app (e.g., a web browser app 202, as further shown in FIG. 2). An app included on a user device 102 to communicate with the search system 100 may display a graphical user interface (GUI) including a search field, or box, into which a user may enter search queries. For example, the user may enter the search queries using a touchscreen, a physical keyboard, a speech-to-text program, or another form of user input available on the user device 102. The app may be configured to transmit the search queries to the search system 100 (e.g., in response to user inputs).

In some examples, the user device 102 may use the same (e.g., dedicated, or more general) app to display the search results received from the search system 100 to the user. For example, the user device 102 may display the search results via the GUI used to receive the search queries from the user and transmit the queries to the search system 100, as described herein. The GUI may display the search results to the user in a variety of different ways, depending on the information transmitted by the search system 100 to the user device 102 as part of the results. As previously described, the search results may include one or more access URLs and function URLs (e.g., AAMs and/or WAMs), as well as display data, result scores, and/or other data used to generate user-selectable links for the URLs. The GUI may display the search results to the user as a list of the user-selectable links, including text and/or images. For example, the text and/or images may describe and/or depict (e.g., using alphanumeric strings, state “screenshots,” and/or app “icons”) the states of the native or web-based apps specified by the access and function URLs. In some examples, the GUI may display the search results as the list of the user-selectable links arranged under the search field, or box, into which the user has entered a search query. For example, the GUI may arrange the user-selectable links by result scores associated with the links (e.g., associated with the access or function URLs for which the links are generated). In additional examples, the GUI may also group the user-selectable links by the associated native or web-based apps (e.g., using app headers).

The data source(s) 104 may be any sources of data that the search system 100 may use to generate and/or update the search data store 112. For example, the search system 100 may use the data source(s) 104 to generate and/or update one or more databases, indices, tables, files, or other data structures (e.g., state records) included in the search data store 112. As an example, the search system 100 may generate new state records and/or update existing state records based on data retrieved from the data source(s) 104. For instance, the search system 100 may include one or more modules (not shown) that generate new state records and/or update existing state records based on the data. In some examples, some or all of the data included in the search data store 112 (e.g., one or more state records) may be manually generated by a human operator.

The data source(s) 104 may include a variety of different data providers. For example, the data source(s) 104 may include data from app developers, such as app developer websites and data feeds provided by app developers. The data source(s) 104 may also include operators of digital distribution platforms configured to distribute apps to user devices. The data source(s) 104 may further include other websites, such as websites that include web logs (i.e., blogs), app reviews, or other data related to apps. Additionally, the data source(s) 104 may include social networking sites, such as “FACEBOOK®” by Facebook Inc. (e.g., Facebook posts) and “TWITTER®” by Twitter Inc. (e.g., text from tweets). The data source(s) 104 may also include other types of data sources, which may have various types of content and update rates. In some examples, the search system 100 may retrieve data from the data source(s) 104, including any type of data related to apps and/or app functionality. The search system 100 may then generate one or more state records based on the data and store the records in the search data store 112. In other examples, some or all of the data (e.g., SI) included in the state records of the search data store 112 may be manually generated by a human operator. Additionally, in some examples, the data included in the state records may be updated over time so that the search system 100 provides up-to-date search results in response to user-specified search queries received from the user device(s) 102.

FIG. 2 illustrates an example of one of the user device(s) 102 in communication with the search system 100 and function result generation system 108. Specifically, FIG. 2 depicts example interactions and data exchanged among the user device 102, search system 100, and function result generation system 108. As shown in FIG. 2, the user device 102 may transmit a query wrapper to the search system 100. The query wrapper may include a search query 212, geo-location data, platform data, and/or other data (e.g., an IP address) associated with the user, the user device 102, and/or the query 212. For example, the user may have entered the search query 212 into a search field 212 of a GUI of a search app 204 included on the user device 102. The user may have then caused the search app 204 to submit the search query 212 to the search system 100 (e.g., as part of the query wrapper) by selecting a search button 214 of the GUI.

Upon receiving the query wrapper from the user device 102, the search system 100 may generate one or more search results 218 based on the search query 212. To generate the search results 218, the search system 100 may identify one or more state records included in the search data store 112 based on the search query 212. The search system 100 may further generate results scores for the identified state records (e.g., rank the identified records). The search system 100 may then select one or more of the identified and ranked state records based on the corresponding results scores and select one or more access URLs 220A (e.g., one or more AAMs and/or WAMs) from each selected record. In some examples, the search system 100 may also select one or more ADMs (e.g., associated with the AAMs) from the selected state records, as described herein. The search system 100 may also determine one or more function URLs 220B (e.g., one or more AAMs and/or WAMs) for the access URLs 220A associated with each selected state record (e.g., using the function result generation system 108). The search system 100 may then transmit the search results 218 to the user device 102 along with one or more ADMs, display data, result scores, and/or other information selected from the records. Each result 218 can include the access URLs 220A and the function URLs 220B associated with one of the selected state records.

In the example of FIG. 2, upon receiving the search results 218 from the search system 100, the user device 102 may display the results 218 to the user as one or more first user-selectable links. For example, the user device 102 may generate the first user-selectable links such that each link is associated with (e.g., includes) the access URLs 220A and the function URLs 220B included in one of the search results 218. As described herein, each access URL 220A and function URL 220B included in the search results 218 may specify a state of a native app (e.g., as in the case of an AAM) or a web-based app (e.g., as in the case of a WAM). As also described herein, the search results 218 may further include one or more ADMs that each indicate a location from which a native app referenced by one of the AAMs included in the search results 218 may be downloaded. In some examples, the user device 102 may generate the first user-selectable links such that at least one of the links is associated with (e.g., includes) one or more of the AAMs and corresponding ADMs. As a result, when the user selects (e.g., touches, pushes, or clicks on) each first user-selectable link using a user input having the first type, the user device 102 may launch a software app (e.g., one of the native app(s) 206, or the web browser app 202, included on the device 102) and set the app into a state (e.g., a native app screen, or a web page) specified by an access URL 220A (e.g., an AAM, or a WAM) included in the link. Alternatively, when the user selects the first user-selectable link using a user input having the second type, the user device 102 may display a second user-selectable link. Upon the user selecting the second user-selectable link using a user input having the first type, the user device 102 may launch a software app and set the app into a state specified by a function URL 220B (e.g., an AAM, or a WAM) included in the first user-selectable link. In some examples, when the user selects the first user-selectable link using the user input having the second type, the user device 102 may also display a third user-selectable link. Upon the user selecting the third user-selectable link using a user input having the first type, the user device 102 may launch a software app and set the app into a state specified by another function URL 220B included in another, adjacent, first user-selectable link. In these examples, the user device 102 may first download a corresponding native app from a location specified by an ADM included in the first user-selectable link (or the adjacent first user-selectable link) and install the app on the device 102. Upon downloading and installing the native app, the user device 102 may launch the app and set the app into the state specified by the access or function URL 220A, 220B (i.e., an AAM) included in the first user-selectable link (or the adjacent first user-selectable link).

In some examples, the user device 102 may receive the user inputs having the first and/or second types using a function input detection module 208 included on the device 102. For example, the function input detection module 208 may be configured to detect the user inputs having the first and/or second types (e.g., to differentiate between the first and second types). In other examples, the user device 102 may display the first, second, and/or third user-selectable links using a function result display module 210 also included on the device 102. For example, the function result display module 210 may be configured to generate the first, second, and/or third user-selectable links in response to the function input detection module 208 detecting the user inputs having the first and/or second types, as described herein.

In some examples, the user device 102 may generate the first, second, and/or third user-selectable links using the display data also included in the search results 218. For example, the display data may include any of text (e.g., describing a name of an app and/or a state of the app) and image data (an icon, or screenshot, associated with the app and/or state). In this manner, the display data included in (e.g., used to generate) each of the first, second, and/or third user-selectable links may describe the app and/or the state of the app associated with the link. The user device 102 may further arrange (e.g., order, or rank) the first, second, and/or third user-selectable links as part of displaying the links to the user based on the result scores also included in the search results 218. As one example, the user device 102 may assign a particular first user-selectable link the result score associated with the state record from which the access URLs 220A included in the link were selected. As another example, the user device 102 may assign a particular second or third user-selectable link the result score determined for the function URL 220B associated with the link. The user device 102 may then order the first, second, and/or third user-selectable links based on the corresponding result scores (e.g., display higher-ranking links higher in a list of user-selectable links). Example search results 218 displayed to a user of a user device 102 as first and second user-selectable links are described with reference to FIGS. 7A-9C.

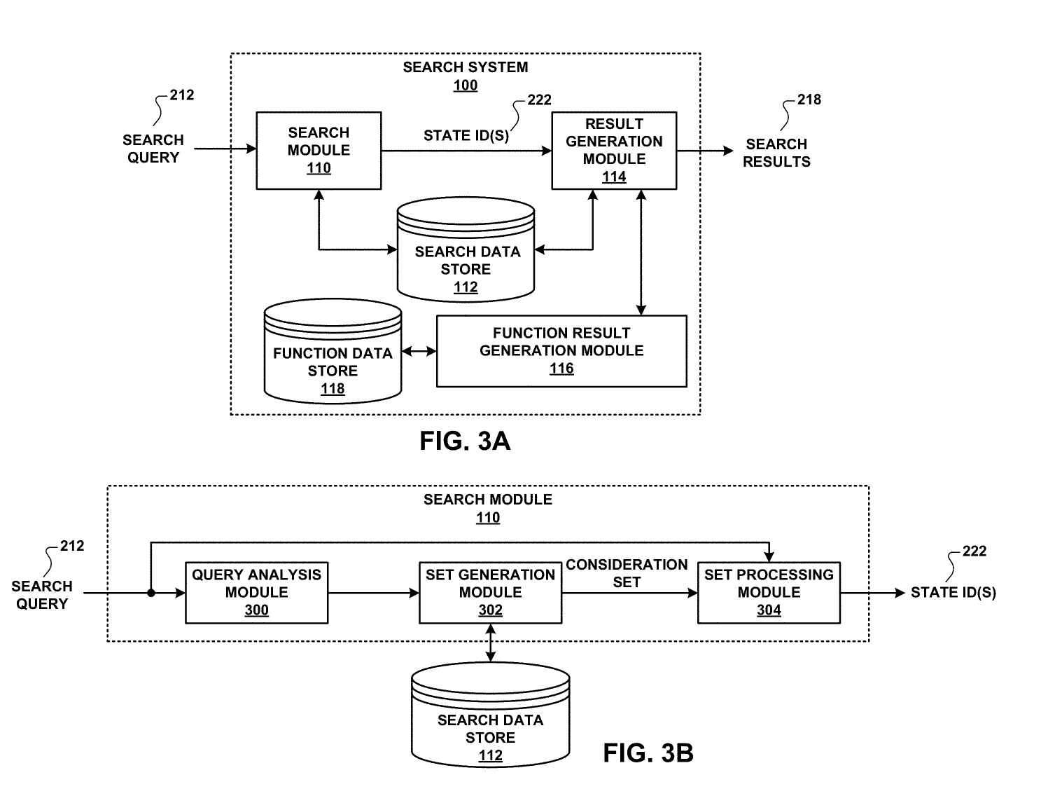

FIG. 3A illustrates an example search system 100. As described herein, the search system 100 generates one or more search results 218 based on a search query 212 received from one of the user device(s) 102 and data included in state records of the search data store 112. Specifically, the search module 110 identifies one or more state records included in the search data store 112 based on the search query 212. In some examples, the search system 100 further ranks the identified state records. The search module 110 then transmits one or more state IDs 222 that identify the state records to the result generation module 114. The result generation module 114 receives the state IDs 222 from the search module 110, identifies the state records in the search data store 112 using the IDs 222, and selects one or more access URLs 220A from the identified records. The result generation module 114 (e.g., using the function result generation module 116 and the function data store 118) also determines one or more function URLs 220B associated with the access URLs 220A. The result generation module 114 then transmits the selected access URLs 220A and the determined function URLs 220B to the user device 102 as the search results 218 (e.g., with display data, result scores, and/or other information associated with the access URLs 220A and function URLs 220B).

FIG. 3B is a functional block diagram of an example search module 110. FIG. 3B also depicts an example search data store 112. The search module 110 includes a query analysis module 300, a consideration set generation module 302 (hereinafter “set generation module 302”), and a consideration set processing module 304 (hereinafter “set processing module 304”). The query analysis module 300 receives a search query 212 from one of the user device(s) 102 (e.g., as part of a query wrapper) and analyzes the query 212 (e.g., performs any of tokenization, filtering, stemming, synonymization, and stop word removal with respect to the query 212). The set generation module 302 identifies one or more state records included in the search data store 112 based on the search query 212 (e.g., an analyzed search query 212). For example, the set generation module 302 may identify state records included in the search data store 112 based on matches (e.g., text matches) between one or more terms of the search query 212 and one or more terms of information (e.g., SI and/or state IDs) included in the records. In a specific example, the set generation module 302 may identify the state records using the search query 212 as an input to Lucene® information retrieval software developed by Apache Foundation. The identified state records may be referred to herein as a “consideration set.”

The set processing module 304 may process the consideration set (e.g., score and select a subset of the consideration set). For example, the set processing module 304 may generate a result score for each state record of the consideration set, thereby ranking the records, and select one or more records from the set having the highest result scores. The set processing module 304 may then transmit one or more state IDs 222 associated with the state records (e.g., the selected state records) of the consideration set to the result generation module 114.

The information conveyed by the search results 218 may depend on how the set processing module 304 generates the result scores for the state records of the consideration set. For example, for each state record, the corresponding result score may be generated based on various features associated with the record, such as relevance of the state of the software app specified by the record to the search query 212, popularity of the state, and/or other properties of the state, depending on the one or more parameters the set processing module 304 uses to score the state records. The set processing module 304 may generate the result scores for the state records in a variety of different ways. In some examples, the set processing module 304 generates a result score for a state record based on one or more scoring features. The scoring features may be associated with the state record, the search query 212, and/or other information. A state record scoring feature (hereinafter, “record scoring feature”) may be based on any data associated with a state record. For example, a record scoring feature may be based on any data included in SI of a state record. An example record scoring feature may be a popularity score (e.g., based on user ratings of a software app or a state of the app) associated with a state record. A query scoring feature may include any data associated with the search query 212. For example, a query scoring feature may include any of a number of words in the search query 212, the popularity of the query 212, and an expected frequency of the words in the query 212. A record-query scoring feature may include any data generated based on information associated with both a state record and a search query 212 that resulted in identification of the record by the set generation module 302. For example, a record-query scoring feature may include any parameters that indicate how well terms of a search query 212 match terms of SI (and/or a state ID) of a state record identified using the query 212. In general, the set processing module 302 may generate a result score for a state record using any of the record, query, and record-query scoring features, and/or any other scoring features not explicitly listed.

In some examples, to generate the result scores for the state records of the consideration set, the set processing module 304 may include one or more machine-learned models (e.g., a supervised learning model, for example, including regression) configured to receive one or more of the record, query, and record-query scoring features described herein. For example, the set processing module 304 may pair the search query 212 with each state record and calculate a vector of features for each (query, record) pair. The vector of features may include one or more record, query, and record-query scoring features. The set processing module 304 may then input the vector of features into a machine-learned relevance (MLR) model to calculate a result score for the state record (e.g., simultaneously based on the features). In some examples, the MLR model may include a set of decision trees (e.g., gradient-boosted decision trees). In other examples, the MLR model may be trained by a form of logistic regression. In still other examples, the machine-learned task described herein can be framed as a semi-supervised learning task, where a minority of training data is labeled with human-curated result scores and the rest of the data is used without such labels.

As described herein, the result scores associated with the state records (e.g., the access URLs 220A included therein) may be used in various different ways. In some examples, the result scores may be used to rank (e.g., order) the access URLs 220A in a list. In these examples, a higher result score may indicate that the corresponding access URL 220A (e.g., a particular state of a software app) is more relevant to the search query 212 (e.g., to the user) than an access URL 220A (e.g., another state of a software app) having a smaller result score. In examples where the search results 218 are displayed as a list of user-selectable links at the user device 102, the links including access URLs 220A associated with larger result scores may be listed closer to the top of the list (e.g., near the top of the screen). In these examples, user-selectable links including access URLs 220A having lower result scores may be located farther down the list (e.g., off screen) and accessed by scrolling down the screen of the user device 102.

In some examples, the function URLs 220B determined for the access URLs 220A included in the state records of the consideration set may also be associated with one or more result scores. The result scores associated with the function URLs 220B may be generated in any manner (e.g., using a machine-learned model, or other techniques) and transmitted to the user device 102 as part of the search results 218. In some examples, the result scores associated with the function URLs 220B may be generated based on whether the corresponding software (e.g., native) apps are installed on the user device 102. The result scores associated with the function URLs 220B may be used in a number of different ways, e.g., to rank the URLs 220B in a list. For example, a higher result score may indicate that the corresponding function URL 220B is more relevant to the user (e.g., references a native app that is installed on the user device 102) than a function URL 220B having a smaller result score (e.g., referencing a native app that is not installed on the user device 102). In examples where the function URLs 220B are displayed as a list of user-selectable links at the user device 102, the links including function URLs 220B associated with larger result scores may be listed closer to the top of the list. In these examples, user-selectable links including function URLs 220B having lower result scores may be located farther down the list and accessed by scrolling down the screen.

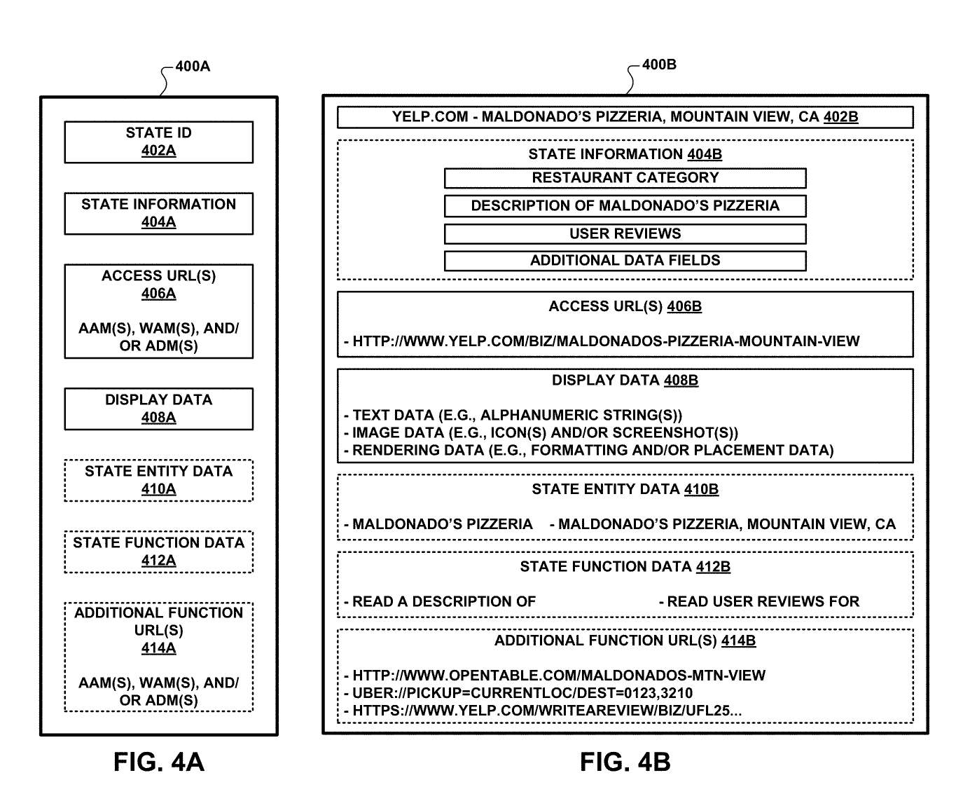

FIGS. 4A-4B illustrate example state records 400A, 400B that may be included in the search data store 112. FIG. 4A illustrates a general example of a state record 400A. The state record 400A of FIG. 4A includes information related to (e.g., specifying) a state of a native or web-based app. As shown in FIG. 4A, the state record 400A includes a state ID 402A that uniquely identifies the record 400A among other state records included in the search data store 112. As also shown, the state record 400A includes SI (e.g., text) 404A that describes the state specified by the record 400A, and which may be used to identify the record 400A in the search data store 112. As further shown, the state record 400A includes one or more access URLs 406A (e.g., AAMs and/or WAMs) that enable a user device 102 to access the state specified by the record 400A in the native or web-based app. As one example, the access URL(s) 406A may include an AAM that references a native app and indicates one or more operations for the app (e.g., a user device 102) to perform. The native app performing the operations may set the app into the state. In response to a user selecting a user-selectable link that includes the AAM on a user device 102, the device 102 may launch the native app and set the app into the state using the AAM. In some examples, the access URL(s) 406 may include and AAM and an ADM. The ADM may specify a location (e.g., a digital distribution platform, such as Google Play® by Google Inc.) where a user device 102 may download the native app referenced by the AAM. In response to a user selecting a user-selectable link that includes the ADM on a user device 102, the device 102 may download the native app using the ADM and install the app. The user device 102 may then launch the native app and set the app into the state using the AAM also included in the user-selectable link. As another example, the access URL(s) 406A may include a WAM that references a web-based app and indicates one or more operations for the app (e.g., a user device 102) to perform. The web-based app performing the operations may set the app into the state. In response to a user selecting a user-selectable link that includes the WAM on a user device 102, the device 102 may launch the web browser app 202 included on the device 102 and access the state using the WAM. For example, the WAM may include a resource ID that references a web resource (e.g., a page of the web-based app, or website). The WAM may include a URL (e.g., a web address) used with HTTP. Upon the user selecting the user-selectable link including the WAM, the user device 102 may launch the web browser app 202 and retrieve the web resource referenced by the resource ID (e.g., access the state, or page, of the web-based app, or website, specified by the WAM). In some examples, the WAM may specify a state of a web-based app that is equivalent (e.g., analogous) to the state specified by the AAM. As also shown, the state record 400A may include display data 408A including text describing and/or image data (e.g., one or more icons, or screenshots) associated with the state of the native or web-based app specified by the record 400A and/or the app itself.

As shown in FIG. 4A, the state record 400A may optionally include one or more of state entity data 410A, state function data 412A, and one or more additional function URLs 414A. The state entity data 410A may indicate one or more entities associated with the state specified by the state record 400A. For example, the state entity data 410A may include one or more alphanumeric strings indicating any of nouns (e.g., a person, animal, place, or thing) and other parts of speech (e.g., verbs, adjectives, etc.). For instance, the state entity data 410A may include one or more alphanumeric strings indicating a name of a business, product, or service, a piece of media content, a political organization/figure, a public figure, a destination, or any other suitable item (e.g., item of commerce) which may be included (e.g., referenced) in a state of a software app.

The state function data 412A may indicate one or more functions (e.g., actions) associated with the state specified by the state record 400A. In particular, the state function data 412A may indicate one or more functions that are each performed with respect to an entity associated with the state (e.g., as indicated by the state entity data 410A). In some examples, the state function data 412A may include one or more alphanumeric strings indicating the functions. For example, the state function data 412A may include one or more standard alphanumeric strings (e.g., “write user reviews,” or “make restaurant reservations”) used to represent the functions. In other examples, the state function data 412A may include one or more numeric values indicating the functions, which may correspond to the standard alphanumeric strings. In still other examples, the state function data 412A may use other (e.g., machine-readable) data to represent the functions.

The additional function URLs, or “function URLs,” 414A may include one or more access URLs (e.g., AAMs and/or WAMs) that each enable a user device 102 to access a state of a native or web-based app other than the state specified by the state record 400A. For example, the function URLs 414A may be analogous in structure and function to the access URL(s) 406A included in the state record 400A. In particular, each of the function URLs 414A may specify a state of a native or web-based app that is associated with an entity also associated with the state specified by the state record 400A (e.g., as indicated by the state entity data 410A). Additionally, the state specified by the function URL 414A is also associated with a function performed with respect to the entity that is different than a function associated with the state specified by the state record 400A (e.g., as indicted by the state function data 412A). In this manner, the function URLs 414A may enable a user device 102 to perform one or more additional functions in addition to the functions associated with the state specified by the state record 400A with respect to the entities associated with the state.

In some examples, the state record 400A may also include display data (not shown) associated with the function URLs 414A, which may include text describing and/or image data associated with the states of the native or web-based apps specified by the URLs 414A and/or the apps themselves, in a similar manner as described with reference to the access URL(s) 406A.

As described herein, the function result generation system 108 may initially determine any of the state entity data 410A, state function data 412A, and function URLs 414A. The search system 100 may then store this information in the state record 400A and later select the information from the record 400A upon identifying the record 400 based on a search query 212 received from one of the user device(s) 102. The search system 100 may include the selected information as part of a search result 218 generated based on the state record 400A.

In additional examples, the state record 400A may include information describing values of one or more metrics associated with a person, place, or thing described in the record 400A. Example metrics include the popularity of the place and/or (e.g., user) ratings of the place. For example, if the state record 400A describes a song, a metric associated with the song may be based on the popularity of the song and/or (e.g., user) ratings of the song. The information included in the state record 400A may also be based on measurements associated with the record 400A, such as how often the record 400A is retrieved during a search and how often user-selectable links generated for any of the access URL(s) 406A of the record 400A are selected by a user. In some examples, the search system 100 (e.g., the set processing module 304) may use this information to generate a result score for the state record 400A (e.g., upon identifying the record 400A and as part of ranking the record 400A among other identified app state records), as described herein.

FIG. 4B illustrates a specific example of a state record 400B that specifies a state of the web-based app “YELP®” by Yelp Inc. (hereinafter, “Yelp”). The state specified by the state record 400B corresponds to an entry in (e.g., a web page of) Yelp for the restaurant “Maldonado's Pizzeria” located in Mountain View, Calif. As shown in FIG. 4B, the state record 400B includes a state ID “Yelp—Maldonado's Pizzeria, Mountain View, Calif.” 402B that uniquely identifies the record 400B among other state records included in the search data store 112. In other examples, the state ID 402B may be a numeric value or have another representation (e.g., machine-readable). As further shown, the state record 400B includes SI 404B that describes the state specified by the record 400B. The SI 404B describes a restaurant category, a description, user reviews, and/or any other information related to the Maldonado's Pizzeria restaurant associated with the state specified by the state record 400B. In some examples, the SI 404B may also describe one or more functions provided by the state, such as “make a restaurant reservation,” “read user reviews,” and “write a user review.” As also shown, the state record 400B includes one or more access URLs 406B (e.g., AAMs and/or WAMs) that enable a user device 102 to access the state specified by the record 400B in Yelp (e.g., the string HTTP://WWW.YELP.COM/BIZ/MALDONADOS-PIZZERIA-MOUNTAIN-VIEW). As also shown, the state record 400B includes display data 408B. The display data 408B includes one or more of text data (e.g., one or more alphanumeric strings), image data (e.g., one or more icons and/or screenshots), and rendering data (e.g., formatting and/or placement data) associated with the entry for the Maldonado's Pizzeria restaurant in Yelp.

As also shown in FIG. 4B, the state record 400B includes state entity data 410B, state function data 412B, and one or more additional function URLs 414B. The state entity data 410B indicates entities associated with the state specified by the state record 400B, including the strings “Maldonado's Pizzeria” and “Maldonado's Pizzeria, Mountain View, Calif.” The state function data 412B indicates functions associated with the state specified by the state record 400B and performed with respect to the entities associated with the state, including the strings “read a description of” and “read user reviews for.” The additional function URLs 414B each specify a state of a native or web-based app other than the state specified by the state record 400B. The state specified by each additional function URL 414B is associated with one of the entities also associated with the state specified by the record 400B (e.g., “Maldonado's Pizzeria, Mountain View, Calif.”). The state specified by each additional function URL 414B is also associated a function performed with respect to the entity (e.g., “make a restaurant reservation”) that is different than any of the functions associated with the state specified by the record 400B. The additional function URLs 414B include the strings “HTTP://WWW.OPENTABLE.COM/MALDONADOS-MTN-VIEW, “UBER://PICKUP=CURRENTLOC/DEST=0123,3210,” and HTTPS://WWW.YELP.COM/WRITEAREVIEW/BIZ/UFL25 . . . ” In some examples, the state record 400B may also include display data (not shown) associated with the function URLs 414B, which may include text describing and/or image data associated with the states of the native or web-based apps specified by the URLs 414B and/or the apps themselves, in a similar manner as described with reference to the access URL(s) 406B.

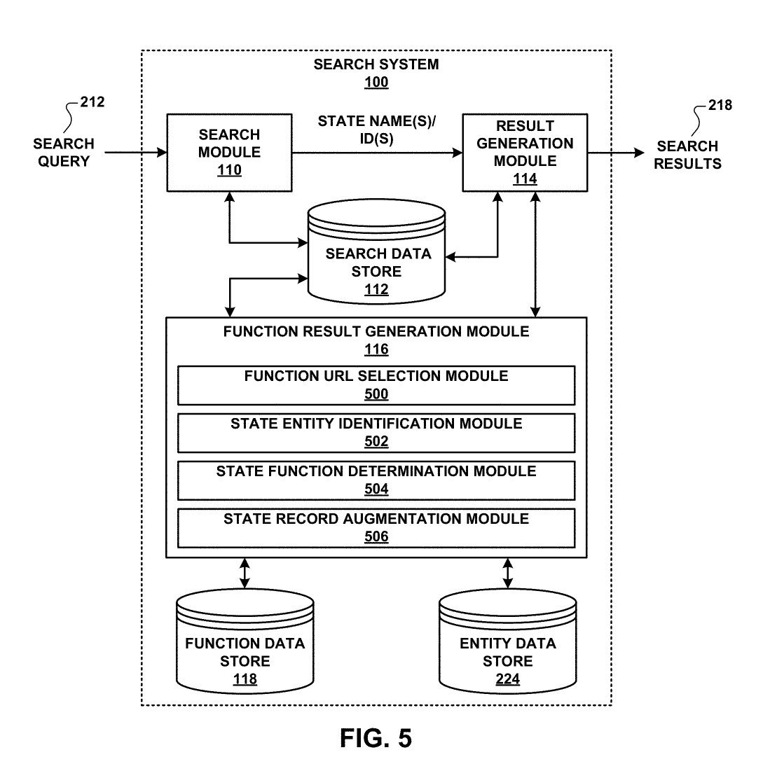

FIG. 5 illustrates an example implementation of the function result generation system 108. In the example of FIG. 5, the function result generation system 108 is included as part of the search system 100. As described herein, the search module 110 may identify one or more state records included in the search data store 112 based on a search query 212 received from one of the user device(s) 102. As also described herein, the result generation module 114 may use the function result generation module 116 and the function data store 118 to determine one or more function URLs 220B for the one or more access URLs 220A selected from the identified state records. As shown in FIG. 5, the function result generation module 116 may include one or more of a function URL selection module 500, a state entity identification module 502, a state function determination module 504, and a state record augmentation module 506.

In some examples, the identified state records may include the function URLs 220B, as described with reference to FIGS. 4A-4B. In these examples, the function URL selection module 500 may be configured to select the function URLs 220B from the identified state records (e.g., by accessing the records in the search data store 112).

In other examples, the identified state records may not include the function URLs 220B. In these examples, the state entity identification module 502 may be configured to initially determine one or more entities associated with the state of the software app specified by each of the identified state records. For example, the state entity identification module 502 may identify the entities based on matches (e.g., text matches) between terms associated with (e.g., displayed as part of) the states and terms included in one or more entity records stored in an entity data store 224. In this example, the entity data store 224, including the entity records, may include one or more databases, indices (e.g., inverted indices), tables, files, or other data structures that may be used to implement the techniques of the present disclosure. In some examples, the state entity identification module 502 may determine one or more entities associated with each state record included in the search data store 112.

Upon the state entity identification module 502 identifying the entities associated with the states of the software apps specified by the identified state records, the state function determination module 504 may be configured to further determine one or more functions associated with the states. As described herein, the functions associated with the states may be performed with respect to the entities associated with the states. Example functions may include “navigate to a location,” “find transportation to a location,” “provide restaurant information,” “order food from a restaurant,” “provide a food photo,” “show a menu,” “find a business,” “provide a user review of a business,” “provide a food recipe,” “send a message,” “check a stock,” “check the weather,” “check a sports score,” “play music,” “play a movie,” “listen to radio station,” and “record a video.” For example, the state function determination module 504 may determine the functions using a function ontology, which may be a data structure (e.g., a database) in the form of a list of one or more functions corresponding to one or more states of one or more software apps. The state function determination module 504 may use the function ontology to assign one or more functions to the state specified by each identified state record. In other words, the state function determination module 504 may assign the functions to the identified state record. In some examples, the state function determination module 504 may assign one or more functions to each state record included in the search data store 112.

In some examples, states of software apps may be marked up (e.g., tagged) with functions by third parties (e.g., app and/or website owners/developers other than those that operate the search system 100 and function result generation system 108). In these examples, the search system 100 and/or the function result generation system 108 may make use of the marked up functions to assign functions to states of software apps. In other examples, a system operator may assign functions to states of software (e.g., web-based) apps at the app and domain level, respectively. For example, a food review app may be assigned the function “read a user review.” The search system 100 and/or the function result generation system 108 may then assign the app-level function “read a user review” to multiple (e.g., all) states of the food review app automatically. As another example, a system operator may assign one or more functions to one or more states of a particular software app. The search system 100 and/or the function result generation system 108 may then assign one or more of the same functions to one or more similar states of the same software app. For example, the system operator may manually assign the function “read a user review” to one of the states and replicate this assignment across one or more other states at the same level in the software app (e.g., all states of the app related to reading using reviews). More specifically, if a function manually assigned to a particular state of a software app relates to reading user reviews about restaurants, any other states of the same app also related to reading user reviews about restaurants may be automatically assigned the same function. As another example, if a state of a movie database software app relates to specific movie information, the state may be manually assigned the function “read movie information” by a system operator. The search system 100 and/or the function result generation system 108 may then apply the function “read movie information” across the remaining states of the movie database software app that each allow a user to view information related to a specific movie.

Upon the state function determination module 504 determining the functions associated with the state specified by each identified state record, the function result generation module 116 may determine one or more function URLs 220B for the one or more access URLs 220A selected from the record (e.g., using data included in the function data store 118). Specifically, each function URL 220B may specify a state of a software app. The state specified by the function URL 220B may be associated with the same entity as any of the entities associated with the state specified by the identified state record. The state specified by the function URL 220B may also be associated with a different function performed with respect to the same entity than any of the functions associated with the state specified by the identified state record. In some examples, the state specified by the function URL 220B may be associated with a function performed with respect to one or more entities (e.g., any business having a geographic location), including any of the entities associated with the state specified by the identified state record. In other words, the state specified by the function URL 220B may be associated with a function performed with respect to a dynamic entity (e.g., an entity placeholder). For example, the state specified by the function URL 220B may correspond to navigating to (e.g., within a native or web-based map software app) or being transported to (e.g., within Uber® by Uber Inc.) to a particular geographic location, which may include a geographic location associated with any of the entities associated with the state specified by the identified state record. In some examples, to determine the function URLs 220B for each identified state record, the function result generation module 116 may select one or more access URLs 220A from one or more other state records included in the search data store 112 that each specify a state of a software app associated with a same entity and a different function performed with respect to the entity compared to the state specified by the identified record, in the manner described herein.

The state record augmentation module 506 may be configured to store indications of any of the determined entities, functions, and function URLs 220B associated with the identified state records in the records (e.g., augment the records), as also described with reference to FIGS. 4A-4B.

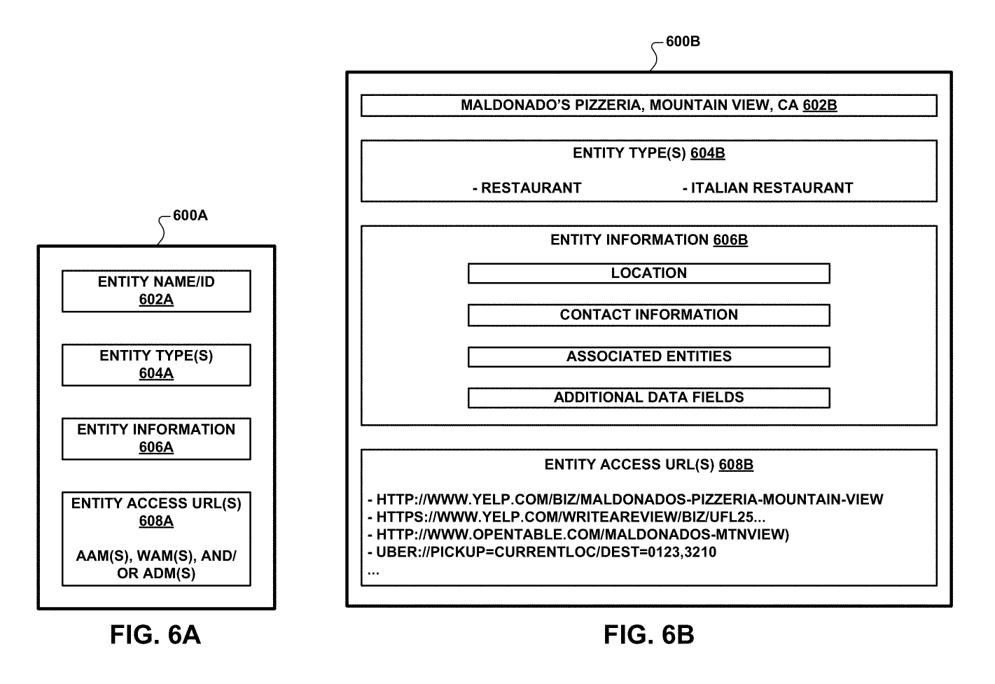

In other examples, the function result generation module 116 may select the function URLs 220B for the access URLs 220A selected from each identified state record from one or more entity records included in the entity data store 224. In these examples, the function result generation module 116 may initially, for each identified state record, identify one or more entities associated with the state of the software app specified by the record. For example, to identify the entities, the function result generation module 116 may use the state entity identification module 502, as previously described, or select indications of the entities from the identified state record. The function result generation module 116 may then identify one or more entity records that each specify one of the entities associated with the state specified by the identified state record. As described with reference to FIGS. 6A-6B, each of the identified entity records may include one or more entity access URLs. Each entity access URL may specify a state of a software app that is associated with the entity specified by the entity record and a function performed with respect to the entity. The function result generation module 116 may further select one or more entity access URLs from the identified entity records as the function URLs 220B for the access URLs 220A selected from the identified state record. Specifically, the function result generation module 116 may select one or more of the entity access URLs that are different that the access URLs 220A. Stated another way, the function result generation module 116 may select one or more of the entity access URLs that specify states of software apps associated with the same entities, but different functions performed with respect to the entities, compared to the state specified by the identified state record.

FIGS. 6A-6B illustrate example entity records 600A, 600B, respectively, that may be stored in the entity data store 224. An entity record may be any data structure that includes information associated with an entity. Stated another way, an entity record may specify an entity. The entity record 600A includes an entity name/ID 602A, an entity type (e.g., category) 604A, and entity information 606A. The entity name/ID 602A may include one or more words, numbers, and/or symbols (e.g., punctuation marks) that may identify the entity record 600A among other entity records included in the entity data store 224. In some examples, the entity name/ID 602A may further describe the entity specified by the entity record 600A. The entity type 604A may indicate one or more categories (e.g., types) to which the entity specified by the entity record 600A belongs. The entity information 606A may be any data included in the entity record 600A in addition to the entity name/ID 602A and entity category 604A. For example, the entity information 606A may describe the entity specified by the entity record 600A. The entity record 600A may optionally include one or more entity access URLs 608A (e.g., AAMs and/or WAMs). As described herein, each of the entity access URL(s) 608A may specify a state of a software app that is associated with the entity specified by the entity record 600A and a function performed with respect to the entity.

The example entity record 600B specifies an entity corresponding to the restaurant “Maldonado's Pizzeria” located in Mountain View, Calif. As shown in FIG. 6B, the entity record 600B includes an entity name/ID “Maldonado's Pizzeria, Mountain View, Calif.” 602B that uniquely identifies the record 600B among other entity records included in the entity data store 224. In other examples, the entity name/ID 602B may be a numeric value or have another representation (e.g., a machine-readable representation). As further shown, the entity record 600B includes one or more entity types 604B associated with the entity specified by the record 600B, including the strings “restaurant” and “Italian restaurant.” As also shown, the entity record 600B includes entity information 606B that describes the entity specified by the record 600B, including data fields that describe a location, contact information, associated entities, and other data associated with the entity. The entity record 600B also includes one or more entity access URLs 608B (e.g., AAMs and/or WAMs), including the strings HTTP://WWW.YELP.COM/BIZ/MALDONADOS-PIZZERIA-MOUNTAIN-VIEW, HTTPS://WWW.YELP.COM/WRITEAREVIEW/BIZ/UFL25 . . . , “HTTP://WWW.OPENTABLE.COM/MALDONADOS-MTNVIEW),” and “UBER://PICKUP=CURRENTLOC/DEST=0123,3210 . . . ”

FIGS. 7A-9C depict example GUIs that may be generated on one of the user device(s) 102 according to this disclosure. In particular, the examples of FIGS. 7A-9C depict the user device 102 performing searches for states of software apps using search queries 212 specified by a user of the device 102. In these examples, although not illustrated, the user may initially enter a search query 212 into a search field 214 of a GUI of a search app 204 executing on the user device 102. The user may then interact with a search button 216 of the GUI to cause the search app 204 to transmit the search query 212 to the search system 100.

The search system 100 may receive the search query 212 from the user device 102 and generate search results 218 that specify states of software apps (e.g., native or web-based apps) based on the query 212. In particular, as described herein, each search result 218 may include an access URL 220A (e.g., an AAM or a WAM) and one or more function URLs 220B (e.g., one or more AAMs and/or WAMs). The access URL 220A may specify a state of a software app, the state associated with an entity and a function performed with respect to the entity. Each function URL 220B may specify a different state of a software app, the different state associated with the same entity and a different function performed with respect to the same entity. To generate the search results 218, the search system 100 may identify state records included in the search data store 112 based on the search query 212 and, e.g., rank the identified records. The search system 100 may then select one or more access URLs 220A from the identified and, e.g., ranked, state records. The search system 100 (e.g., using the function result generation system 108) may further determine one or more function URLs 220B for the access URLs 220A, as described herein. The search system 100 may then transmit the search results 218, including the access URLs 220A and function URLs 220B, to the user device 102.

The user device 102 receives the search results 218 from the search system 100 in response to transmitting the search query 212 to the system 100. As shown in FIG. 7A, the user device 102 (e.g., the search app 204) operating using ANDROID® displays each search result 218 to the user as a first user-selectable link within a GUI 700. Each first user-selectable link may be configured to, upon being selected by a user input having a first type, cause the user device 102 to set a software app into the state specified by an access URL 220A included in the corresponding search result 218 (not shown). The first user-selectable link may be further configured to, upon being selected by a user input 702 having a second, different, type, cause the user device 102 to display a second, different, user-selectable link, as shown in FIG. 7B. The second user-selectable link may be configured to, upon being selected by a user input having the first type, cause the user device 102 to set a software app into the different state specified by a function URL 220B included in the corresponding search result 218, as shown in FIG. 7C. For example, the user device 102 may generate the first user-selectable links using display data (e.g., text and/or image data) received from the search system 100 in the search results 218.

As shown in FIG. 7A, a first user-selectable link displayed for a particular one of the search results 218 is associated with a state of a native or web-based version of Yelp corresponding to an entry for a Maldonado's Pizzeria restaurant located in Mountain View, Calif. As shown, the user device 102 may receive a user input 702 having the second type, the input 702 selecting this particular first user-selectable link. As shown in FIG. 7B, in response to receiving the user input 702, the user device 102 (e.g., the search app 204) may display the second user-selectable link associated with the same search result 218 (e.g., in a function menu/list including a plurality of links). As shown, the second user-selectable link is associated with a state of a native or web-based app “OPENTABLE®” by OpenTable Inc. (hereinafter, “OpenTable”) corresponding to an entry for the same Maldonado's Pizzeria restaurant. In this manner, the first user-selectable link (e.g., the access URL 220A) may specify a state of Yelp that is associated with the Maldonado's Pizzeria restaurant and one or more functions (e.g., “read user reviews,” etc.) performed with respect to the restaurant. The second user-selectable link (e.g., the function URL 220B) may specify a different state of OpenTable that is associated with the same Maldonado's Pizzeria restaurant and a different function (e.g., “make a restaurant reservation”) performed with respect to the same restaurant.

As shown in FIG. 7B, the user device 102 may display the second user-selectable link in a GUI 704 that includes the link and one or more other user-selectable links. In this example, the user device 102 displays the second user-selectable link in a first portion 708 of a list 706 (e.g., a function list/menu), the portion 708 including one or more other second user-selectable links associated with the same search result 218 and generated in a similar manner as previously described. Also in this example, the user device 102 displays one or more additional user-selectable links in a second portion 710 (e.g., a default menu of links) of the list 706 (e.g., adjacent to the second user-selectable links). The additional user-selectable links may be configured to, upon being selected by a user input having the first type, cause the user device 102 to set a predetermined software app into a particular state (e.g., a predetermined state). In the examples of FIGS. 7A-7C, additional user-selectable links associated with different search result 218 may be the same. For example, each additional user-selectable link may be configured to, upon being selected by a user input having the first type, cause the user device 102 to perform the same function (e.g., “open,” “open in new window,” “save link,” “copy link URL,” and “select text”) with respect to the corresponding search result 218 (e.g., with respect to the entity associated with the result 218) irrespective of the result 218. For example, the user device 102 may generate the second user-selectable links (e.g., additional user-selectable links) using display data received from the search system 100 as part of the search results 218.

As shown in FIGS. 7A-7B, the user device 102 may also rank the first, second, and/or additional user-selectable links in a list. For example, the user device 102 may order each user-selectable link based on the result score associated (e.g., received) with the corresponding search result 218. In the example of FIG. 7B, the user device 102 may order each second user-selectable link (e.g., in the first portion 708, or in the list 706 including the first and second portions 708, 710) based whether the corresponding software app is installed on the device 102.

As shown in FIG. 7B, the user may select one of the second user-selectable links using a user input 702 having the first type, namely the link associated with a state of Yelp corresponding to writing user reviews for the Maldonado's Pizzeria restaurant. As shown in FIG. 7C, upon the user selecting the second user-selectable link, the user device 102 may launch Yelp and set Yelp into the state specified by the link (e.g., using an AAM or a WAM included in the link). Specifically, as shown in FIG. 7C, the user device 102 may configure Yelp to display a GUI 712 corresponding to the state. Upon the user device 102 setting Yelp into the state, the user may interact with the state (e.g., write a user review for the restaurant). As described herein, in some examples, upon the user selecting any of the first and second user-selectable links, the device 102 may first download and install the corresponding native app (e.g., Yelp, OpenTable, or Uber) using an ADM included in the link. The user device 102 may then launch the native app and set the app into the state specified by the selected user-selectable link.

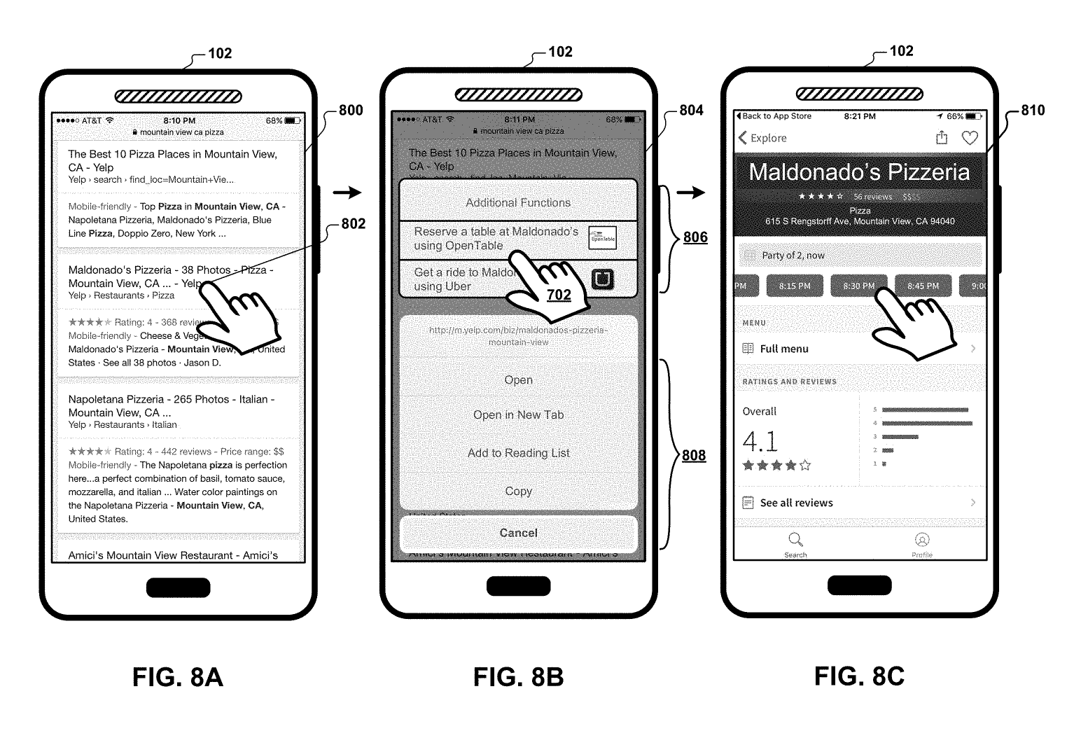

FIGS. 8A-8C depict some of the same elements and user interactions as those shown in FIGS. 7A-7C. The user device 102 of FIGS. 8A-8C is operating using IOS®. As shown in FIG. 8A, the user device 102 may receive a user input 802 having the second type, the input 802 selecting a first user-selectable link that is analogous to the first user-selectable link described with reference to FIGS. 7A-7C. As shown in FIG. 8B, in response to receiving the user input 802, the user device 102 may display a second user-selectable link associated with the same search result 218 as the first user-selectable link. As shown, the second user-selectable link is analogous to the second user-selectable link described with reference to FIGS. 7A-7C.

As shown in FIG. 8B, the user device 102 may display the second user-selectable link in a GUI 804 that includes the link and one or more other user-selectable links. In this example, the user device 102 displays the second user-selectable link in a first list 806, the list 806 including one or more other second user-selectable links associated with the same search result 218 and generated in a similar manner as described herein. Also in this example, the user device 102 displays one or more additional user-selectable links in a second, different list 808 (e.g., separate from the second user-selectable links). The additional user-selectable links are analogous to the additional user-selectable link described with reference to FIGS. 7A-7C. As also shown, the user device 102 may further order each second user-selectable link in the first list 806 based whether the corresponding software app is installed on the device 102. The user device 102 may also order each additional user-selectable link in the second list 808 using one or more corresponding result scores or other logic.

As shown in FIG. 8B, the user may select one of the second user-selectable links using a user input 802 having the first type, namely the link associated with a state of OpenTable corresponding to making a restaurant reservation at the particular Maldonado's Pizzeria restaurant. As shown in FIG. 8C, upon the user selecting the second user-selectable link, the user device 102 may launch OpenTable and set OpenTable into the state (e.g., including a GUI 810) specified by the link, in a similar manner as described with reference to FIGS. 7A-7C. Upon the user device 102 setting OpenTable into the state, the user may interact with the state (e.g., make a restaurant reservation at the Maldonado's Pizzeria restaurant).

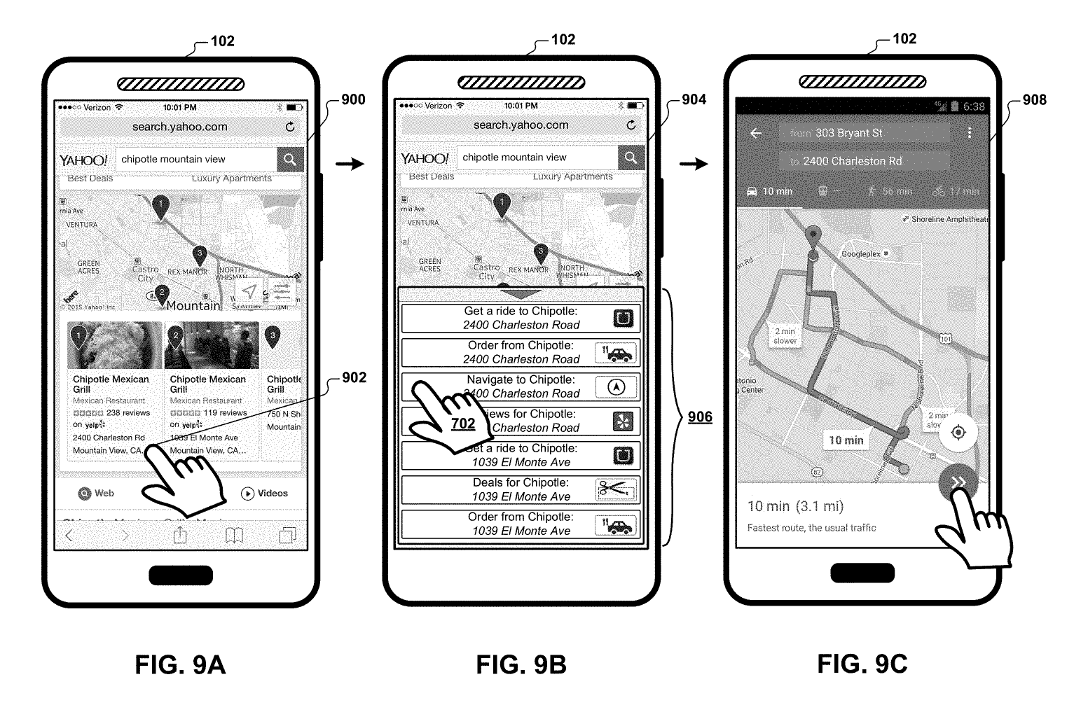

FIGS. 9A-9C depict some of the same elements and user interactions as those shown in FIGS. 7A-8C. The user device 102 of FIGS. 9A-9C is operating using IOS®. As shown in FIG. 9A, the user device 102 displays two of the search results 218 to the user as two adjacent first user-selectable links within a GUI 900. The first user-selectable link displayed for each of the two search results 218 may be configured to, upon being selected by a user input having a first type, cause the user device 102 to set a software app into the state specified by an access URL 220A included in the result 218 (not shown). The first user-selectable link may be further configured to, upon being selected by a user input 902 having a second type (e.g., different than the first type), cause the user device 102 to display second and third user-selectable links, as shown in FIG. 9B. The second user-selectable link may be configured to, upon being selected by a user input having the first type, cause the user device 102 to set a software app into the different state specified by a function URL 220B included in the search result 218, as shown in FIG. 9C. The third user-selectable link, in turn, may be configured to, upon being selected by a user input having the first type, cause the user device 102 to set a software app into the different state specified by a function URL 220B included in the other one of the two search results 218. For example, the user device 102 may generate the first user-selectable links using display data received from the search system 100 in the search results 218, in a similar manner as previously described.

As shown in FIG. 9A, the adjacent first user-selectable links displayed for the two search results 218 are associated with states of a native or web-based version of Yelp corresponding to entries for different Chipotle Mexican Grill (hereinafter, “Chipotle”) restaurants located in Mountain View, Calif. As shown, the user device 102 may receive a user input 902 having the second type, the input 902 selecting one of the first user-selectable links associated with a first one of the Chipotle restaurants. As shown in FIG. 9B, in response to receiving the user input 902, the user device 102 may display the second and third user-selectable links associated with the selected first user-selectable link (e.g., with the corresponding one of the two search results 218). As shown, the second user-selectable link is associated with a state of a native app “UBER®” by Uber Inc. (hereinafter, “Uber”) corresponding to being driven to the first Chipotle restaurant. As also shown, the third user-selectable link is associated with a state of Uber corresponding to being driven to a second, different one of the Chipotle restaurants associated with the other one of the first user-selectable links. In this manner, the selected first user-selectable link (e.g., the corresponding access URL 220A) may specify a state of Yelp that is associated with the first Chipotle restaurant and one or more functions (e.g., “read user reviews,” etc.) performed with respect to the restaurant. The second user-selectable link (e.g., the corresponding function URL 220B) may specify a different state of Uber that is associated with the first Chipotle restaurant and a different function (e.g., “get a ride to”) performed with respect to the first restaurant. The third user-selectable link (e.g., the corresponding function URL 220B included in the other one of the two search results 218) may specify another state of Uber that is associated with the second Chipotle restaurant and a function (e.g., “get a ride to”) performed with respect to the second restaurant.

As shown in FIG. 9B, the user device 102 may display the second and third user-selectable links in a GUI 904 that includes the links and one or more other user-selectable links. In this example, the user device 102 displays the second and third user-selectable links in a list 906 including one or more other second and third user-selectable links associated with the two search results 218 and generated in a similar manner as previously described. Also in this example, the user device 102 displays one or more additional user-selectable links in the list 906 (e.g., adjacent to the second and third user-selectable links). The additional user-selectable links are analogous to the additional user-selectable link described with reference to FIGS. 7A-8C. As also shown, the user device 102 may further order the second and third user-selectable links in the list 906 based whether the corresponding software app is installed on the device 102. The user device 102 may also order each additional user-selectable link in the second list 906 using one or more corresponding result scores or other logic.

As shown in FIG. 9B, the user may select one of the second and third user-selectable links using a user input 902 having the first type, namely a second user-selectable link associated with a state of a native mapping app corresponding to navigating to the first Chipotle restaurant. As shown in FIG. 9C, upon the user selecting the second user-selectable link, the user device 102 may launch the native mapping app and set the app into the state (e.g., including a GUI 908) specified by the link, in a similar manner as described with reference to FIGS. 7A-8C. Upon the user device 102 setting the native mapping app into the state, the user may interact with the state (e.g., navigate to the first Chipotle restaurant).

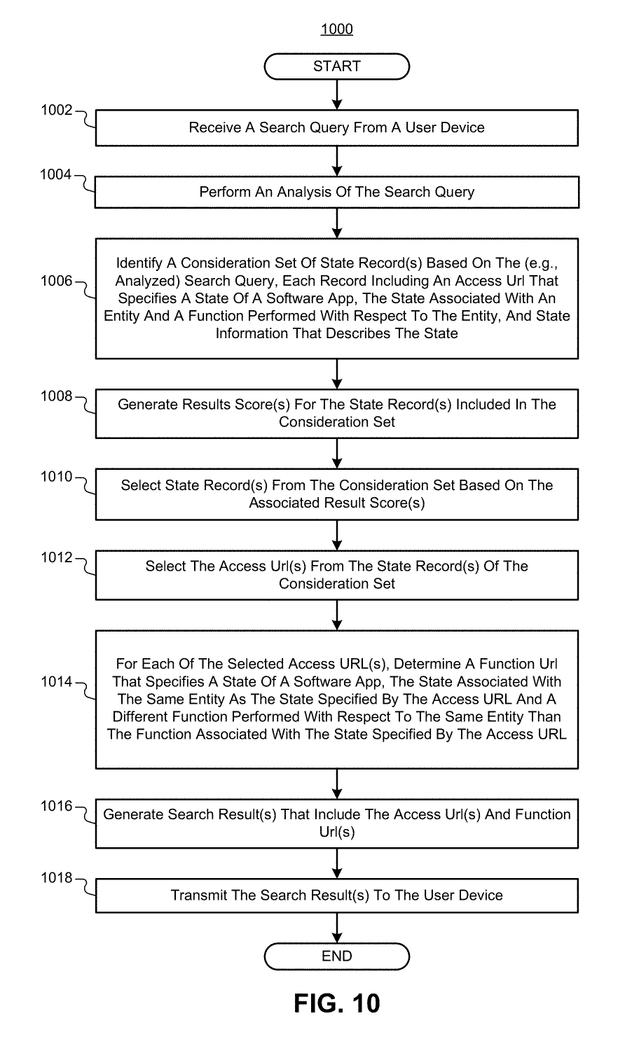

FIG. 10 is a flow diagram that illustrates an example method 1000 for generating search results 218 based on a search query 212 using the search system 100. In block 1002, the search system 100 may initially receive a search query 212. In block 1004, the search system 100 (e.g., the query analysis module 300) may optionally perform an analysis of the search query 212 (e.g., any of tokenization, filtering, stemming, synonymization, and stop word removal with respect to the query 212). In some examples, the search system 100 may receive additional information from the user device 102 (e.g., as part of the query wrapper, or separately), such as user information and/or geo-location, platform, and IP address information associated with the device 102, as described herein.

In block 1006, the search system 100 (e.g., the set generation module 302) may identify a consideration set of one or more state records included in the search data store 112 based on the search query 212 (e.g., an analyzed search query 212). As described herein, each identified state record of the consideration set may include an access URL 220A that specifies a state of a software (e.g., native or web-based) app and SI (e.g., text) that describes the state. As also described herein, the state specified by the access URL 220A included in each identified state record may be associated with an entity (e.g., a particular restaurant) and a function (e.g., “write a user review”) that may be performed with respect to the entity in the state.

In blocks 1008-1010, the search system 100 (e.g., the set processing module 304) may optionally process the consideration set of state records. Specifically, in block 1008, the search system 100 may generate one or more result scores for the state records included in the consideration set (e.g., generate a result score for each state record). In block 1010, the search system 100 (e.g., the set processing module 304) may select one or more state records from (e.g., select a subset of) the consideration set based on the one or more result scores associated with the selected records. For example, the search system 100 may select one or more state records of the consideration set having the highest (e.g., largest) one or more result scores.

In block 1012, the search system 100 (e.g., the result generation module 114) may select the one or more access URLs 220A from the state records (e.g., the selected state records) of the consideration set (e.g., select the access URL 220A from each record). In some examples, the search system 100 (e.g., the result generation module 114) may also select other information associated with and/or included in the state records (e.g., the selected state records) of the consideration set, such as display data, result scores, and/or other data, as also described herein.

In block 1014, the function result generation system 108 (e.g., the function result generation module 116) may, for each of the selected access URLs 220A (e.g., for the corresponding one of the state records of the consideration set) determine a function URL 220B that specifies a state of a software (e.g., native or web-based) app. As described herein, the state specified by the function URL 220B determined for each of the selected access URLs 220A may be associated with the same entity (e.g., the particular restaurant) as the state specified by the access URL 220A. As also described herein, the state specified by the function URL 220B may be associated with a different function (e.g., “make a reservation”) that may be performed with respect to the same entity in the state than the function associated with the state specified by the access URL 220A. For example, the function result generation system 108 (e.g., the function result generation module 116) may determine the one or more function URLs 220B for the selected access URLs 220A using any of a variety of techniques. In some examples, as described herein, the function result generation system 108 may select the function URLs 220B from the state records (e.g., the selected state records) of the consideration set (e.g., select each function URL 220B from one of the records). In these examples, the function result generation system 108 (e.g., the function result generation module 116) may also select other information associated with and/or included in the state records (e.g., the selected state records) relating to the function URLs 220B, such as display data, result scores, and/or other data. In other examples, as also described herein, the function result generation system 108 may retrieve the function URLs 220B and other information from another location (e.g., from an entity record).

In block 1016, the search system 100 (e.g., the result generation module 114) may generate one or more search results 218 that include the selected access URLs 220A and the determined function URLs 220B. For example, the search system 100 may generate the search results 218 such that each result 218 includes one of the access URLs 220A, the other information selected from each state record (e.g., from each selected state record), and the function URL 220B determined for the access URL 220A (e.g., for the record). In block 1018, the search system 100 (e.g., the result generation module 114) may transmit the search results 218, including the selected access URLs 220A, the selected other information, and the determined function URLs 220B to the user device 102.

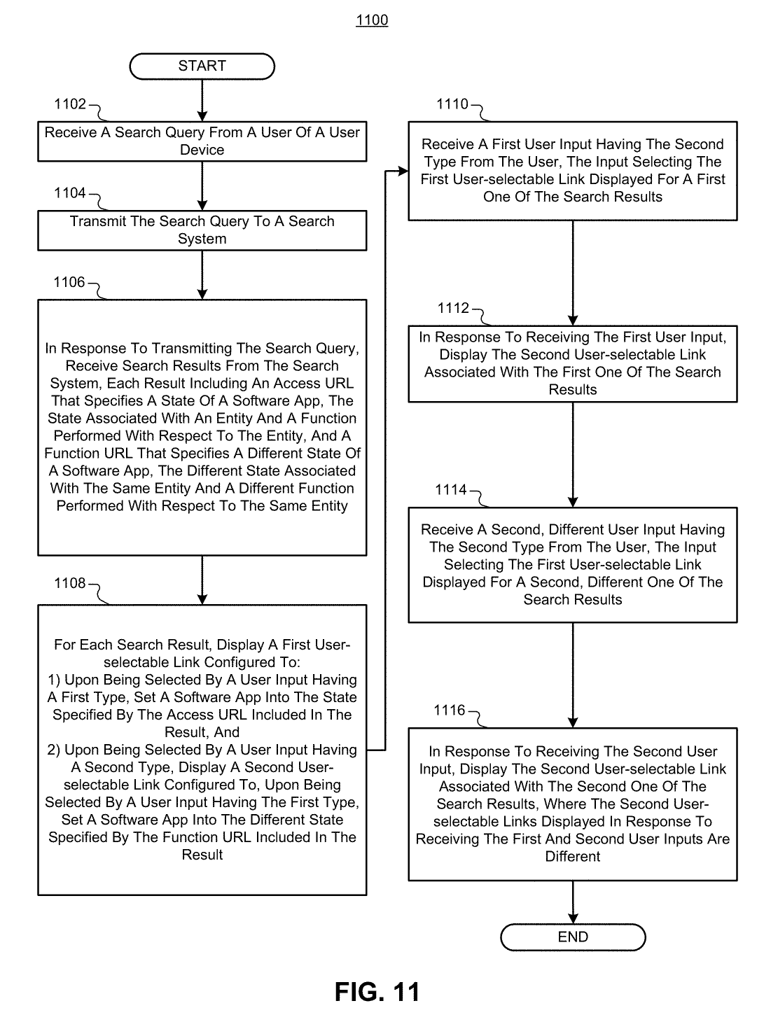

FIG. 11 is a flow diagram that illustrates an example method 1100 for generating search results 218 based on a search query 212 using one of the user device(s) 102. In block 1102, one of the user device(s) 102 may initially receive a search query 212 from a user of the device 102. As described herein, the user device 102 may receive the search query 212 from the user via a search app 204 executing on the device 102. In block 1104, the user device 102 may transmit the search query 212 to the search system 100. As also described herein, the user device 102 may transmit the search query 212 to the search system 100 in response to receiving an input from the user via the search app 204. In this example, the search system 100 may receive the search query 212 from the user device 102 and generate one or more search results 218 based on the query 212. For example, the search results 218 may include one or more access URLs 220A, function URLs 220B, display data, result scores, and/or other data. The search system 100 may then transmit the search results 218 to the user device 102.

Accordingly, in block 1106, the user device 102 may receive the search results 218 from the search system 100 in response to transmitting the search query 212 to the system 100. As described herein, each search result 218 may include an access URL 220A that specifies a state of a software app (e.g., a native or web-based app). In this example, the state may be associated with an entity (e.g., a particular restaurant) and a function (e.g., “write a user review”) that may be performed with respect to the entity in the state. As also described herein, the search result 218 may further include a function URL 220B that specifies a different state of a software app (e.g., the same app, or a different app). In this example, the different state specified by the function URL 220B may be associated with the same entity (e.g., the restaurant) as the state specified by the access URL 220A. Also in this example, the different state specified by the function URL 220B may be associated with a different function (e.g., “make a reservation”) that may be performed with respect to the same entity in the different state compared to the function associated with the state specified by the access URL 220A. As further described herein, each search result 218 may also include other information associated with the access and function URLs 220A, 220B, such as display data, result scores, and/or other data.

In block 1108, the user device 102 (e.g., the search app 204) may, for each of the received search results 218, display a first user-selectable link. As described herein, the first user-selectable link displayed for each search result 218 may be configured to, upon being selected by a user input having a first type (e.g., a momentary tap, push, or click, or a shallow push), set a software app into the state specified by the access URL 220A included in the result 218. As also described herein, the first user-selectable link may be further configured to, upon being selected by a user input having a second, different type (e.g., a prolonged tap, push, or click, or a deep push), display a second, different user-selectable link. As further described herein, the second user-selectable link may be configured to, upon being selected by a user input having the first type, set a software app into the different state specified by the function URL 220B included in the search result 218. For example, the user device 102 may generate the first user-selectable link for each search result 218 to include the access URL 220A, the function URL 220B, and the display data and/or other information received with the result 218 from the search system 100. The user device 102 may then display each first user-selectable link. In some examples, to display the first user-selectable links for the search results 218, the user device 102 may further rank (e.g., arrange in an order) the links based on the corresponding result scores received with the results 218 from the search system 100 (e.g., arrange the links in an order of decreasing result scores).

In block 1110, the user device 102 (e.g., the search app 204) may receive a first user input having the second type from the user. In this example, the first user input may select the first user-selectable link displayed for a first one of the received search results 218. In block 1112, in response to receiving the first user input, the user device 102 (e.g., the search app 204) may display the second user-selectable link associated with the first one of the received search results 218. In block 1114, the user device 102 (e.g., the search app 204) may receive a second, different user input having the second type from the user. In this example, the second user input may select the first user-selectable link displayed for a second, different one of the received search results 218. In block 1116, in response to receiving the second user input, the user device 102 (e.g., the search app 204) may display the second user-selectable link associated with the second one of the received search results 218. In these examples, the second user-selectable links displayed in response to receiving the first and second user inputs may be different.

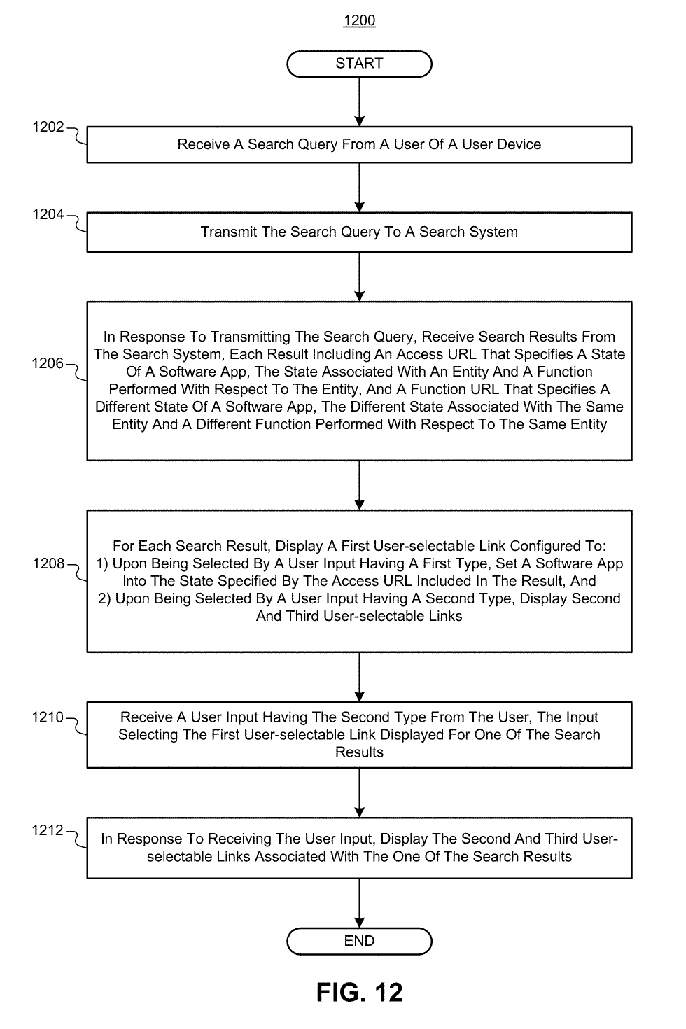

FIG. 12 is a flow diagram that illustrates another example method 1200 for generating search results 218 based on a search query 212 using one of the user device(s) 102. Blocks 1202-1206 of the method 1200 are analogous to blocks 1102-1106 of the method 1100. In block 1208, the user device 102 (e.g., the search app 204) may, for each of the received search results 218, display a first user-selectable link. As described herein, the first user-selectable link displayed for each search result 218 may be configured to, upon being selected by a user input having a first type, set a software app into the state specified by the access URL 220A included in the result 218. As also described herein, the first user-selectable link may be further configured to, upon being selected by a user input having a second, different type, display second and third, different user-selectable links. In this example, the second user-selectable link may be configured to, upon being selected by a user input having the first type, set a software app into the different state specified by the function URL 220B included in the search result 218. Also in this example, the third user-selectable link may be configured to, upon being selected by a user input having the first type, set a software app into the different state specified by the function URL 220B included in another one of the search results 218. In this example, the first user-selectable links displayed for the two search results may be displayed adjacent to one another. The user device 102 may generate the first user-selectable link for each search result 218 to include the access URL 220A, the function URL 220B, and the display data and/or other information received with the result 218 from the search system 100 and then display the link. In some examples, the user device 102 may further rank the first user-selectable links based on the corresponding result scores received with the results 218 from the search system 100.

In block 1210, the user device 102 (e.g., the search app 204) may receive a user input having the second type from the user. In this example, the user input may select the first user-selectable link displayed for one of the received search results 218. In block 1212, in response to receiving the user input, the user device 102 (e.g., the search app 204) may display the second and third user-selectable links associated with the one of the received search results 218.

The modules and data stores included in the search system 100 and function result generation system 108 represent features that may be included in these systems 100, 108 as they are described in the present disclosure. For example, the search module 110, search data store 112, and result generation module 114 may represent features included in the search system 100. Similarly, the function result generation module 116 and function data store 118 may represent features included in the function result generation system 108. The modules and data stores described herein may be embodied by electronic hardware, software, and/or firmware. Depiction of different features as separate modules and data stores does not necessarily imply whether the modules and data stores are embodied by common or separate electronic hardware, software, and/or firmware components. In some implementations, the features associated with the modules and data stores depicted herein may be realized by one or more common or separate electronic hardware, software, and/or firmware components.

The modules and data stores may be embodied by electronic hardware, software, and/or firmware components including, but not limited to, one or more processing units, memory components, input/output (I/O) components, and interconnect components. The interconnect components may be configured to provide communication between the processing units, memory components, and I/O components. For example, the interconnect components may include one or more buses configured to transfer data between electronic components. The interconnect components may also include control circuits (e.g., a memory controller and/or an I/O controller) configured to control communication between electronic components.

The processing units may include one or more central processing units (CPUs), graphics processing units (GPUs), digital signal processing units (DSPs), or other processing units. The processing units may be configured to communicate with the memory components and I/O components. For example, the processing units may be configured to communicate with the memory components and I/O components via the interconnect components.

A memory component (memory) may include any volatile or non-volatile media. For example, the memory may include electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray disc), or any other memory components. The memory components may include (e.g., store) the data described herein. For example, the memory components may store the data included in the state records 400 of the search data store 112 and/or the data included in (e.g., entity records of) the function data store 118. The memory components may also include instructions executed by the processing units. For example, the memory components may include computer-readable instructions that, when executed by the processing units, cause the units to perform the various functions attributed to the modules and data stores described herein.

The I/O components may refer to electronic hardware, software, and/or firmware that provide communication with a variety of different devices. For example, the I/O components may provide communication between other devices and the processing units and memory components. In some examples, the I/O components may be configured to communicate with a computer network. For example, the I/O components may be configured to exchange data over a computer network using a variety of different physical connections, wireless connections, and protocols. The I/O components may include network interface components (e.g., a network interface controller), repeaters, network bridges, network switches, routers, and firewalls. In some examples, the I/O components may include hardware, software, and/or firmware configured to communicate with various human interface devices, including display screens, keyboards, pointer devices (e.g., a mouse), touchscreens, speakers, and microphones. In other examples, the I/O components may include hardware, software, and/or firmware configured to communicate with additional devices, such as external memory (e.g., external HDDs).

In some examples, the search system 100 and/or function result generation system 108 may be a system of one or more computing devices (e.g., a computer search system) configured to implement the techniques described herein. Put another way, the features attributed to the modules and data stores described herein may be implemented by one or more computing devices. Each computing device may include any combination of electronic hardware, software, and/or firmware described herein. For example, each computing device may include any combination of the processing units, memory components, I/O components, and interconnect components described herein. The computing devices may also include various human interface devices, including display screens, keyboards, pointing devices (e.g., a mouse), touchscreens, speakers, and microphones. The computing devices may also be configured to communicate with additional devices, such as external memory (e.g., external HDDs).

The computing devices of the search system 100 and/or function result generation system 108 may be configured to communicate with the network 106. The computing devices may also be configured to communicate with one another via a computer network. In some examples, the computing devices may include one or more server computing devices configured to communicate with the user device(s) 102 (e.g., receive search queries 212 and transmit search results 218), gather data from the data source(s) 104, index the data, store the data, and store other documents. In other examples, the computing devices may reside within a single machine at a single geographic location, within multiple machines at a single geographic location, or be distributed across a number of geographic locations.

Additionally, the various implementations of the search system 100 and function result generation system 108 described herein (e.g., using one or more computing devices that include one or more processing units, memory components, I/O components, and interconnect components) are equally applicable to any of the user device(s) 102, as well as to the various components thereof.

What is claimed is:

1. A method comprising:
receiving, at a user device, a search query from a user;
transmitting, using the user device, the search query to a search system;
in response to transmitting the search query, receiving, at the user device, search results from the search system, each result including an access URL that specifies a state of a software application (app), the state associated with an entity and a function performed with respect to the entity, and a function URL that specifies a different state of a software app, the different state associated with the same entity and a different function performed with respect to the same entity;
for each of the search results, displaying, at the user device, a first user-selectable link configured to, upon being selected by a user input having a first type, cause the user device to set a software app into the state specified by the access URL included in the result, and, upon being selected by a user input having a second type, cause the user device to display a second, different, user-selectable link, the second user-selectable link configured to, upon being selected by a user input having the first type, cause the user device to set a software app into the different state specified by the function URL included in the result;
receiving, at the user device, a first user input having the second type, the input selecting the first user-selectable link displayed for a first one of the search results;
in response to receiving the first user input, displaying the second user-selectable link associated with the first one of the search results;
receiving, at the user device, a second, different user input having the second type, the input selecting the first user-selectable link displayed for a second one of the search results; and
in response to receiving the second user input, displaying the second user-selectable link associated with the second one of the search results, wherein the second user-selectable links displayed in response to receiving the first and second user inputs are different.

2. The method of claim 1, wherein one or more of the first and second user inputs each comprises a finger contact input received at a capacitive touchscreen of the user device.

3. The method of claim 1, wherein one or more of the first and second user inputs each comprises a pressure input received at a pressure-sensitive display of the user device.

4. The method of claim 1, wherein one or more of the first and second user inputs each comprises a cursor selection input received via one or more of a computer mouse and a trackpad of the user device.

5. The method of claim 1, wherein one of the first and second types comprises a momentary input having a short time duration, and wherein another one of the first and second types comprises a prolonged input having a longer time duration than that of the momentary input.

6. The method of claim 1, wherein one of the first and second types comprises a shallow input having a small depression depth with respect to a pressure-sensitive display of the user device, and wherein another one of the first and second types comprises a deep input having a larger depression depth with respect to the pressure-sensitive display than that of the shallow input.

7. The method of claim 1, wherein one of the first and second types comprises a first gesture with respect to a display of the user device, and wherein another one of the first and second types comprises a second, different gesture with respect to the display.

8. The method of claim 1, wherein the first user-selectable link is further configured to, upon being selected by a user input having the second type, cause the user device to display an additional, different user-selectable link adjacent to the second user-selectable link, the additional user-selectable link configured to, upon being selected by a user input having the first type, cause the device to set a software app into a state, the method further comprising:
in response to receiving the first and second user inputs, displaying the additional user-selectable links associated with the first and second ones of the search results, wherein the additional user-selectable links are the same.

9. The method of claim 1, wherein, for at least one of the search results, the first user-selectable link is further configured to, upon being selected by the user input having the second type, cause the user device to order the second user-selectable link in a list of user-selectable links based on whether the software app associated with the function URL included in the result is installed on the user device.

10. The method of claim 1, wherein, for at least one of the search results, the access URL and the function URL specify states of the same software app.

11. The method of claim 1, wherein, for at least one of the search results, the access URL and the function URL specify states of the different software apps.

12. A method comprising:
receiving, at a user device, a search query from a user;
transmitting, using the user device, the search query to a search system;
in response to transmitting the search query, receiving, at the user device, search results from the search system, each result including an access URL that specifies a state of a software application (app), the state associated with an entity and a function performed with respect to the entity, and a function URL that specifies a different state of a software app, the different state associated with the same entity and a different function performed with respect to the same entity;
for each of the search results, displaying, at the user device, a first user-selectable link configured to, upon being selected by a user input having a first type, cause the user device to set a software app into the state specified by the access URL included in the result, and, upon being selected by a user input having a second type, cause the user device to display second and third user-selectable links, the second user-selectable link configured to, upon being selected by a user input having the first type, cause the user device to set a software app into the different state specified by the function URL included in the result, and the third user-selectable link configured to, upon being selected by a user input having the first type, cause the user device to set a software app into the different state specified by the function URL included in another one of the search results for which the first user-selectable link is displayed adjacent to the first user-selectable link displayed for the result.

13. The method of claim 12, wherein the user input comprises a finger contact input received at a capacitive touchscreen of the user device.

14. The method of claim 12, wherein the user input comprises a pressure input received at a pressure-sensitive display of the user device.

15. The method of claim 12, wherein the user input comprises a cursor selection input received via one or more of a computer mouse and a trackpad of the user device.

16. The method of claim 12, wherein one of the first and second types comprises a momentary input having a short time duration, and wherein another one of the first and second types comprises a prolonged input having a longer time duration than that of the momentary input.

17. The method of claim 12, wherein one of the first and second types comprises a shallow input having a small depression depth with respect to a pressure-sensitive display of the user device, and wherein another one of the first and second types comprises a deep input having a larger depression depth with respect to the pressure-sensitive display than that of the shallow input.

18. The method of claim 12, wherein one of the first and second types comprises a first gesture with respect to a display of the user device, and wherein another one of the first and second types comprises a second gesture with respect to the display.

19. The method of claim 12, wherein, for at least one of the search results, the first user-selectable link is further configured to, upon being selected by the user input having the second type, cause the user device to order at least one of the second and third user-selectable links in a list of user-selectable links based on whether the software app associated with the link is installed on the device.

20. A computing device comprising:
a network interface component configured to communicate with a network;
an input/output (I/O) component configured to receive a search query and first and second user inputs from a user of the computing device;
a display;
one or more memory components configured to store computer-readable instructions; and
one or more processing units configured to execute the computer-readable instructions, wherein the computer-readable instructions, when executed by the one or more processing units, cause the one or more processing units to:
receive the search query from the user using the I/O component;
transmit the search query to a search system via the network using the network interface component;
in response to transmitting the search query, receive search results from the search system via the network using the network interface component, each result including an access URL that specifies a state of a software application (app), the state associated with an entity and a function performed with respect to the entity, and a function URL that specifies a different state of a software app, the different state associated with the same entity and a different function performed with respect to the same entity;
for each of the search results, display at the display a first user-selectable link configured to, upon being selected by a user input having a first type, cause the computing device to set a software app into the state specified by the access URL included in the result, and upon being selected by a user input having a second type, cause the device to display at the display a second, different user-selectable link, the second user-selectable link configured to, upon being selected by a user input having the first type, cause the device to set a software app into the different state specified by the function URL included in the result;
receive the first user input from the user using the I/O component, the input having the second type and selecting the first user-selectable link displayed for a first one of the search results;
in response to receiving the first user input, display at the display the second user-selectable link associated with the first one of the search results;
receive the second user input from the user using the I/O component, the input having the second type and selecting the first user-selectable link displayed for a second, different one of the search results; and
in response to receiving the second user input, display at the display the second user-selectable link associated with the second one of the search results, wherein the second user-selectable links displayed in response to receiving the first and second user inputs are different.
